(19) United States
(12) Patent Application Publication
(10) Pub. No.: US 2025/0121765 A1
(43) Pub. Date: Apr. 17, 2025

(54) ADJUSTABLE DECK SYSTEM FOR CARGO COMPARTMENT

(71) Applicant: Ancra International LLC, Hebron, KY (US)

(72) Inventors: Matthew James ROMMEL, Independence, KY (US); Jerome Thomas JONES, Independence, KY (US)

(21) Appl. No.: 18/916,971

(22) Filed: Oct. 16, 2024

Related U.S. Application Data
(60) Provisional application No. 63/590,730, filed on Oct. 16, 2023.

(51) Int. Cl. B60P 3/08

(52) U.S. Cl. CPC B60P 3/08

(57) ABSTRACT

This disclosure relates to an adjustable deck system that may be moved to various positions inside a cargo container to provide a second cargo loading deck inside the cargo container. The adjustable deck system includes first and second decks that may be moved to various heights in the cargo container. The second deck is positioned at a rear portion of the cargo container, and a rear end of the second deck may be lowered from a raised position down to a floor position creating a ramp for loading cargo onto the first deck. In some examples, the entire second deck may be lowered and raised independently of the first deck to enable the second deck to operate as an elevator system. Automated lift and support assemblies are provided for controlling movement and support of the adjustable deck system to and at various positions inside the cargo container.

### CROSS-REFERENCE TO RELATED APPLICATIONS

This application claims the benefit of U.S. Provisional Application No. 63/590,730 (filed Oct. 16, 2023). The aforementioned application is hereby incorporated by reference in its entirety.

### BACKGROUND

Transport vehicles of various types are used for hauling cargo of many different sizes. In a typical transport vehicle, a cargo container is permanently or temporarily secured to a truck chassis or to a trailer to be pulled by tractor vehicle. If such cargo containers are used for carrying low profile cargo, placement of a layer of such cargo on a floor surface of the container may leave an abundance of empty space in the container above the layer of cargo.

### DETAILED DESCRIPTION OF DRAWINGS

The present systems and methods for an adjustable deck system for cargo compartment are described in detail below with reference to these figures.

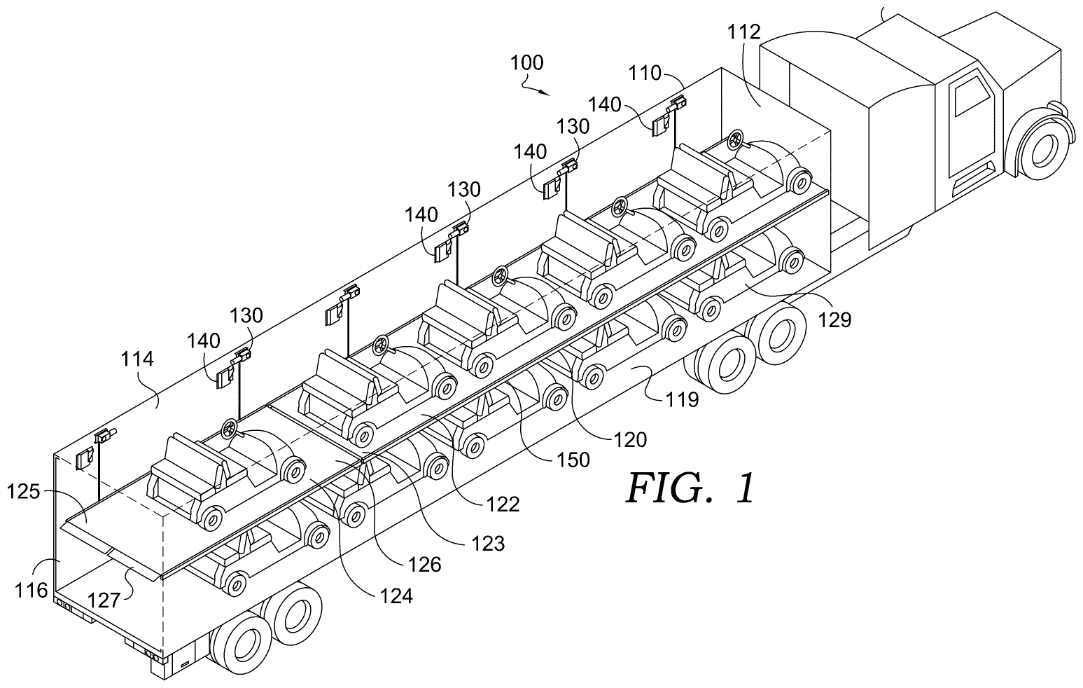

FIG. 1 depicts a perspective view of a cargo trailer and tractor combination showing a cargo container with an adjustable deck system, in accordance with examples of this disclosure.

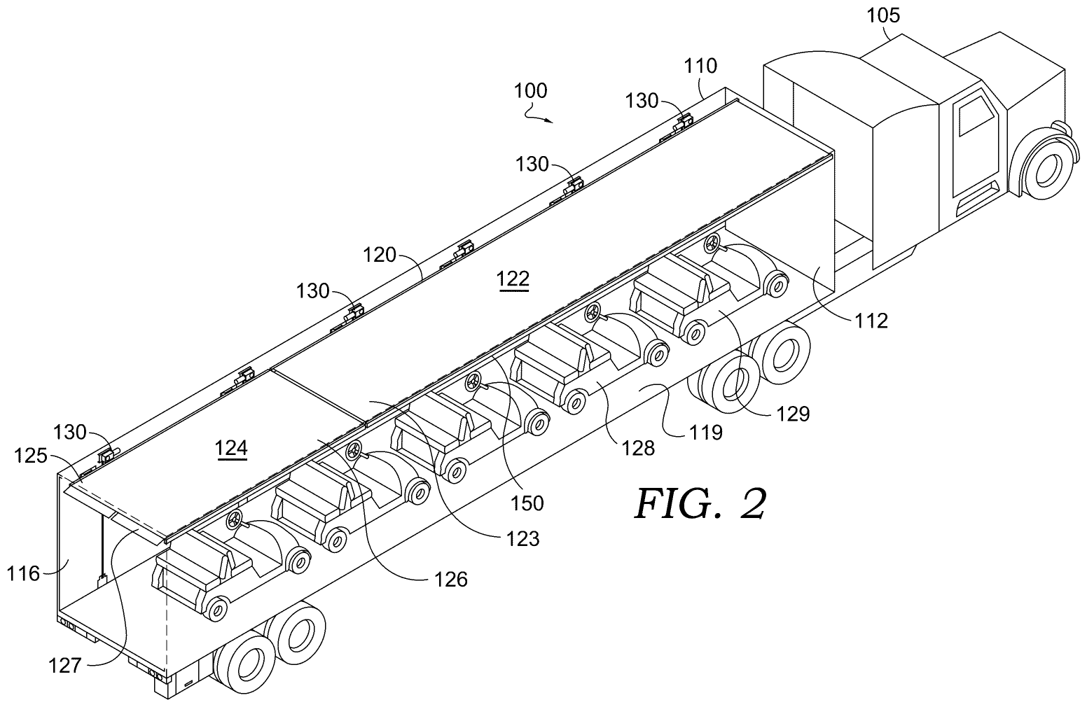

FIG. 2 depicts a perspective view of the cargo trailer and tractor combination of FIG. 1 showing the adjustable deck system in a fully raised position, in accordance with examples of this disclosure.

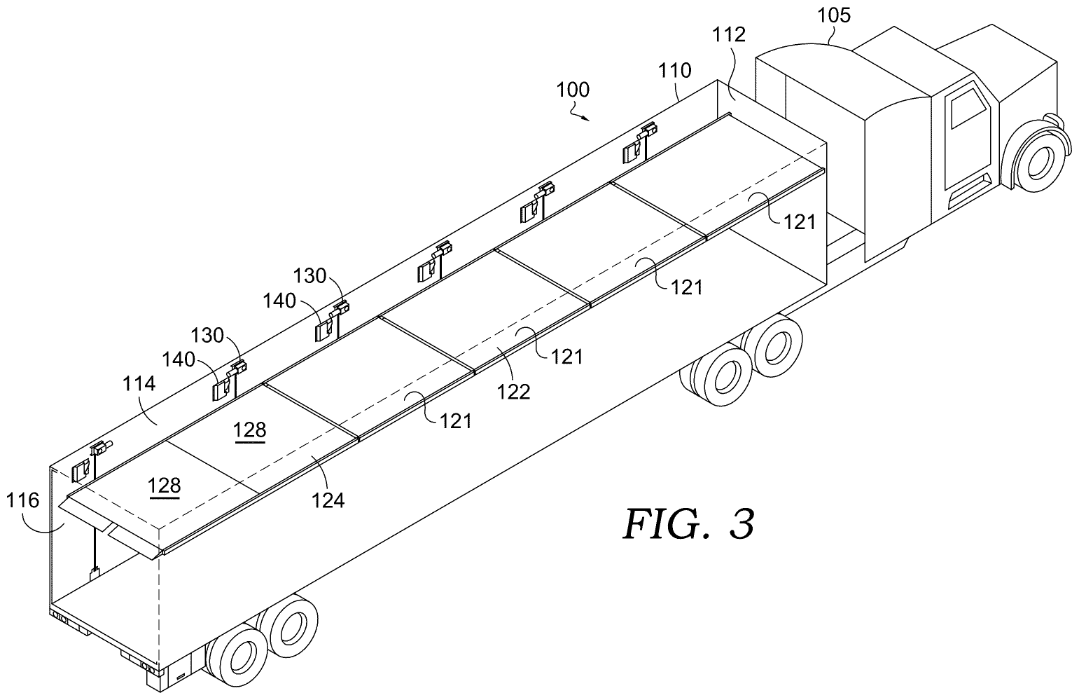

FIG. 3 depicts a perspective view of the cargo trailer and tractor combination of FIG. 1 showing the adjustable deck system in a fully raised position and showing first and second cargo decks comprised of a plurality of independently adjustable deck sections, in accordance with examples of this disclosure.

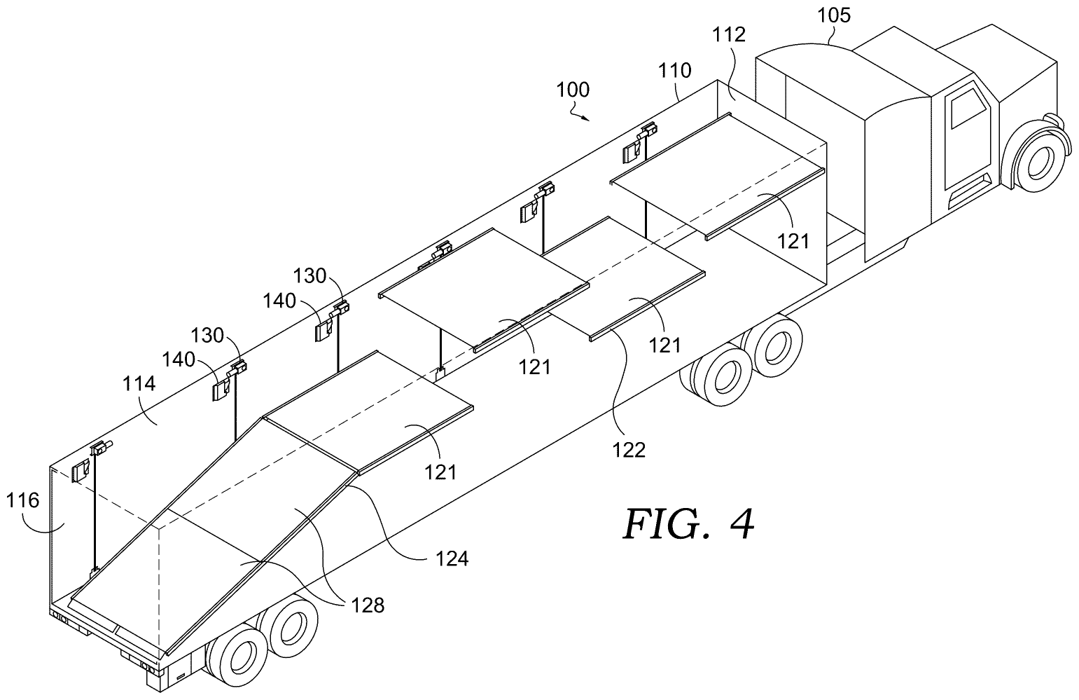

FIG. 4 depicts a perspective view of the cargo trailer and tractor combination of FIG. 3 showing the second deck lowered to a ramped orientation and showing the plurality of independently adjustable deck sections of the first deck positioned a different cargo levels inside the cargo trailer.

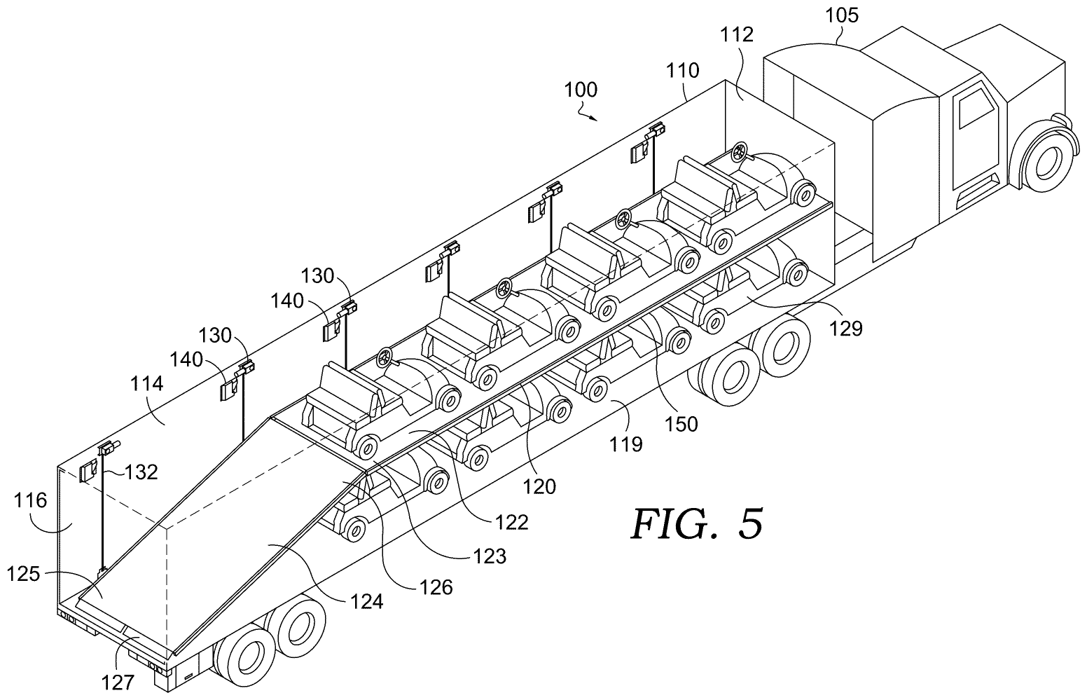

FIG. 5 depicts a perspective view of the cargo trailer and tractor combination of FIG. 1 showing a second deck lowered to a cargo ramped orientation, in accordance with examples of this disclosure.

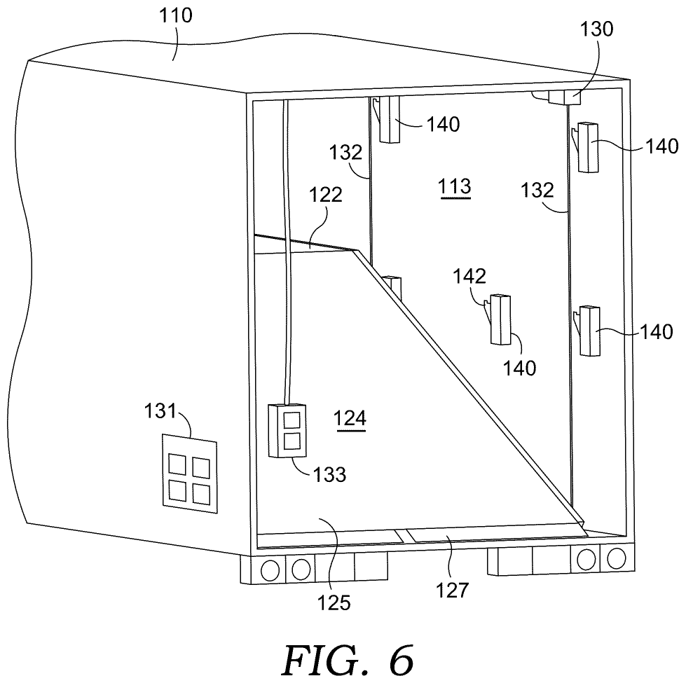

FIG. 6 depicts a perspective view of a rear portion of the cargo container of FIGS. 1-5 showing the second deck lowered to a cargo ramped orientation, in accordance with examples of this disclosure.

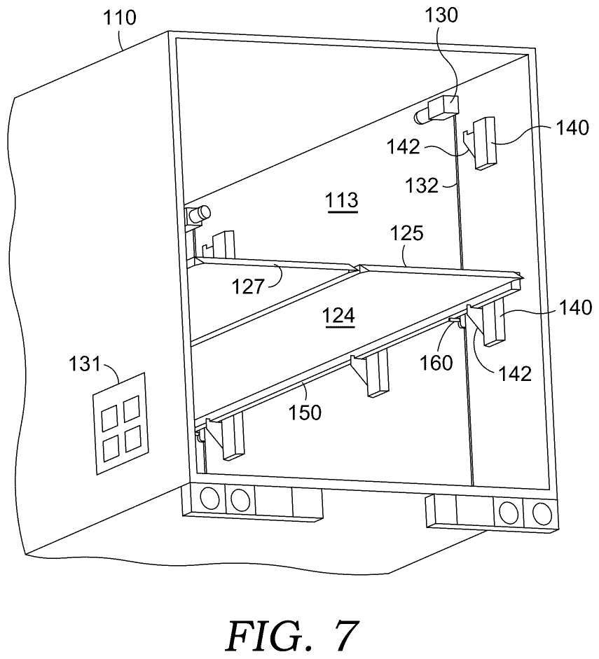

FIG. 7 depicts a perspective view of a rear portion of the cargo container of FIG. 6 showing the second deck raised to a horizontal orientation, in accordance with examples of this disclosure.

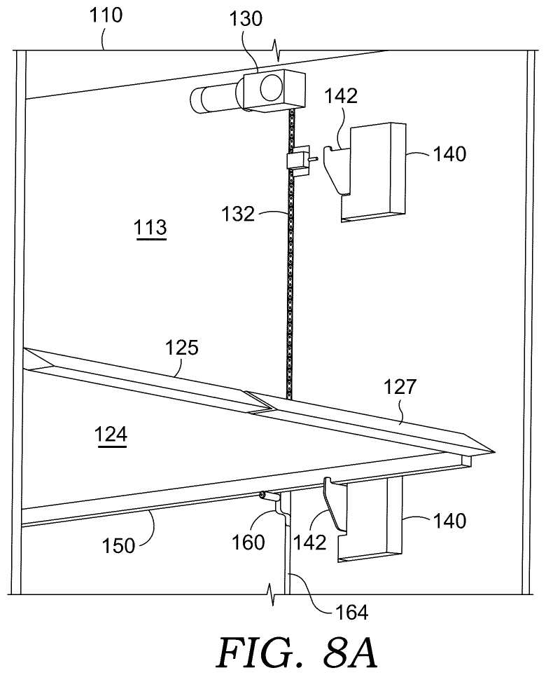

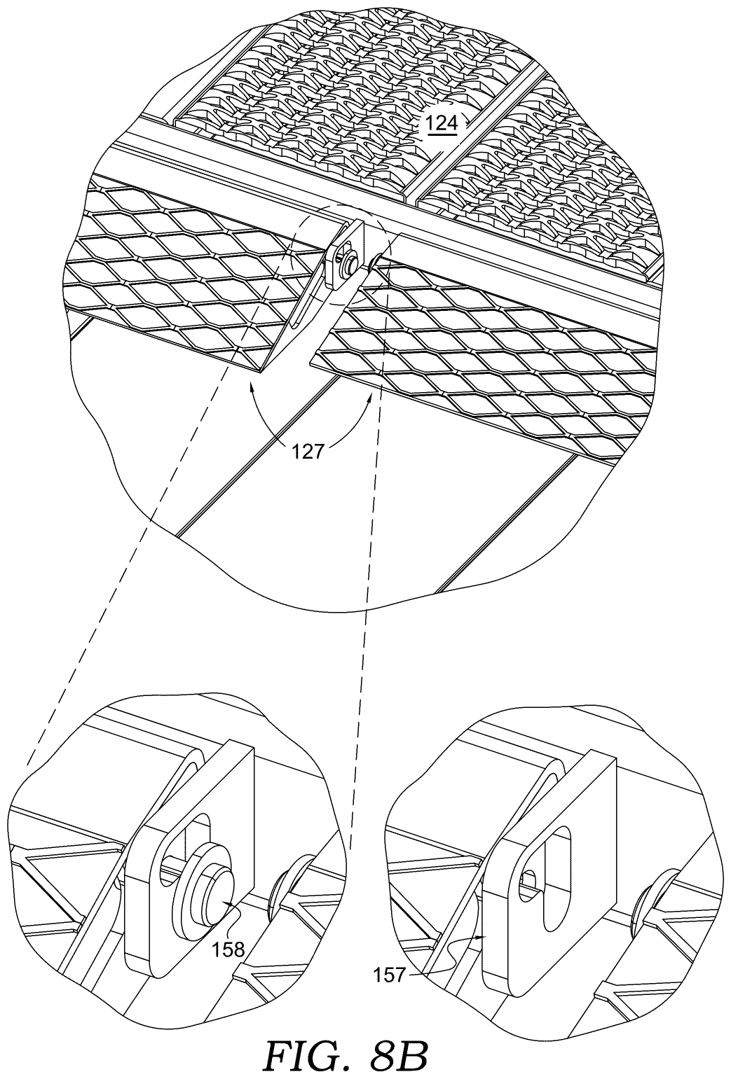

FIG. 8A depicts a perspective view of a rear portion of the cargo container of FIG. 7 showing the second deck raised to a horizontal orientation and showing various components operative for raising, lowering and supporting the second deck, in accordance with examples of this disclosure.

FIG. 8B depicts a perspective view of a rear portion of the cargo container of FIG. 7 showing the second deck with ramp assist members, in accordance with examples of this disclosure.

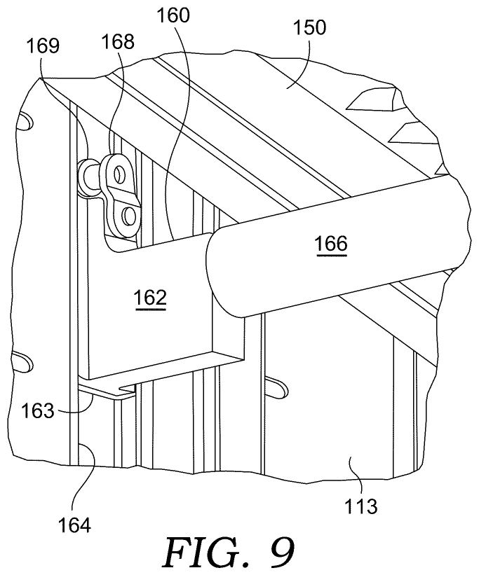

FIG. 9 depicts a perspective view of a movable deck lift support that moves with the second deck between horizontal and ramped orientations, in accordance with examples of this disclosure.

FIG. 10 depicts a side view of components of the adjustable deck system of FIG. 1 showing a portion of first and second decks and various components operative for raising, lowering and supporting the adjustable deck system, in accordance with examples of this disclosure.

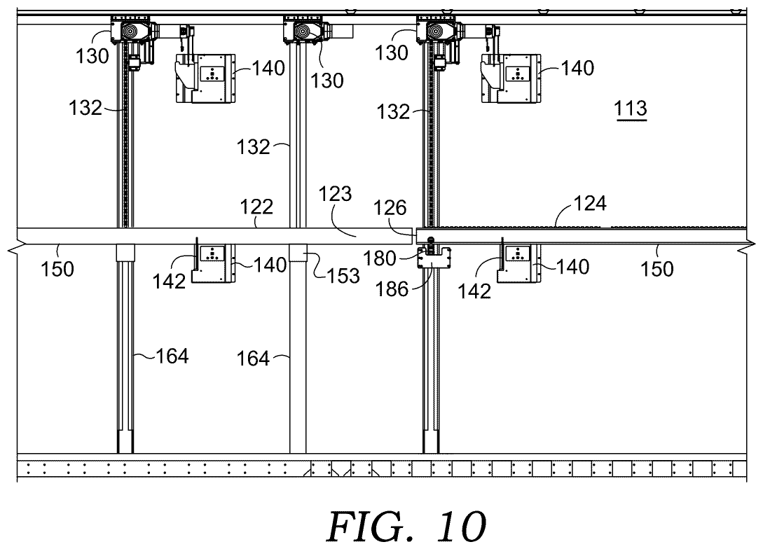

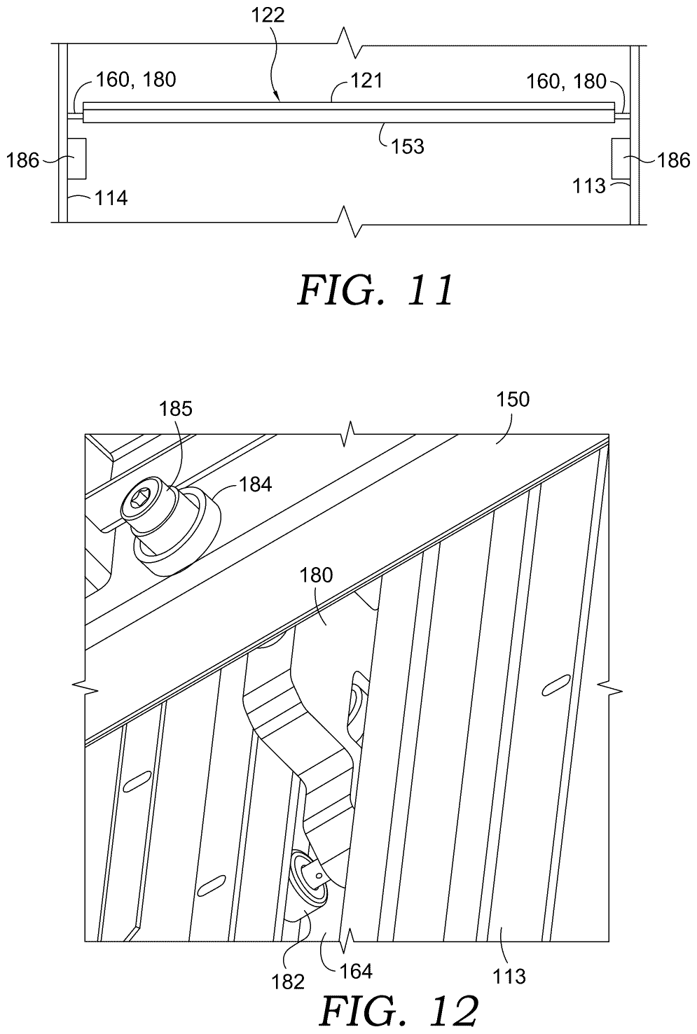

FIG. 11 depicts a forward view of a portion of the first deck of the adjustable deck system of FIG. 1 showing alternative components operative for raising, lowering and supporting the first deck or sections of the first deck of the adjustable deck system, in accordance with examples of this disclosure.

FIG. 12 depicts a perspective view of components operative for raising, lowering and supporting the adjustable deck system of FIG. 10, in accordance with examples of this disclosure.

FIG. 13 depicts a perspective view of a movable deck lift support associated with a forward end of a second deck of the adjustable deck system of FIG. 12, in accordance with examples of this disclosure.

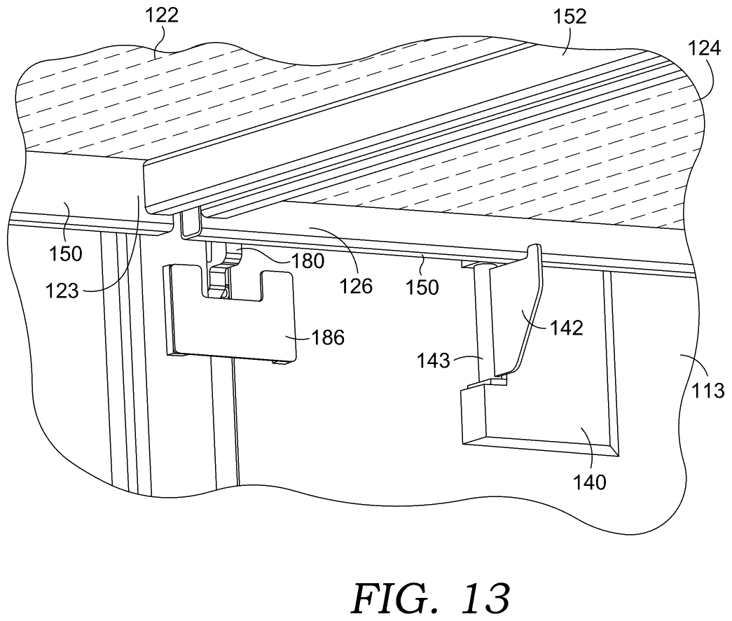

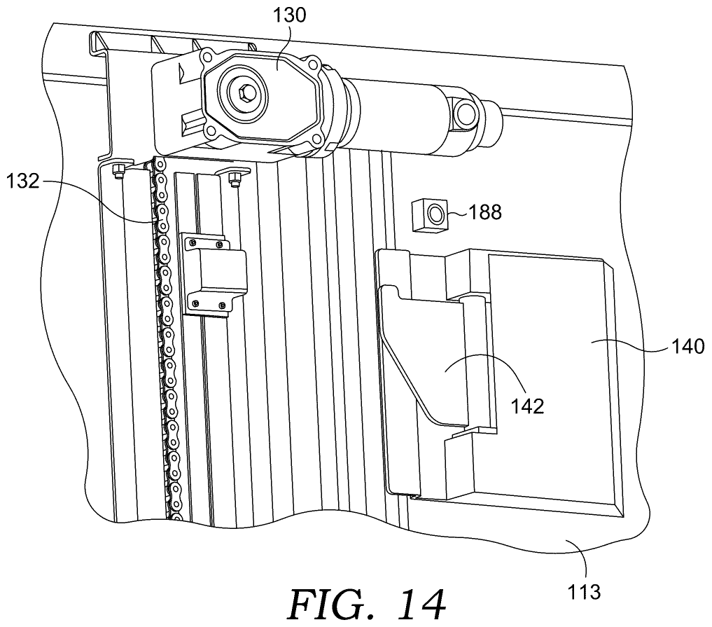

FIG. 14 depicts a perspective view of components operative for raising, lowering and supporting the adjustable deck system of FIGS. 1-5, in accordance with examples of this disclosure.

FIG. 15 depicts a perspective view of the adjustable deck system deck support assembly showing a rotatable support truss and showing a cutaway view of control components of the deck support assembly, in accordance with examples of this disclosure.

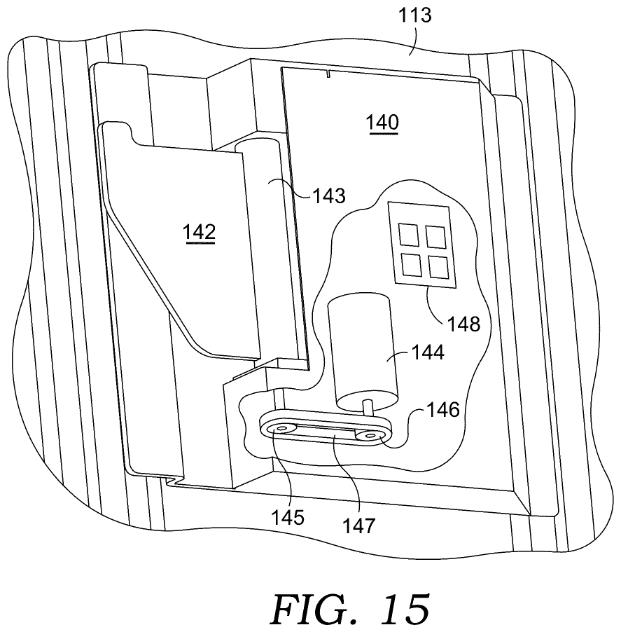

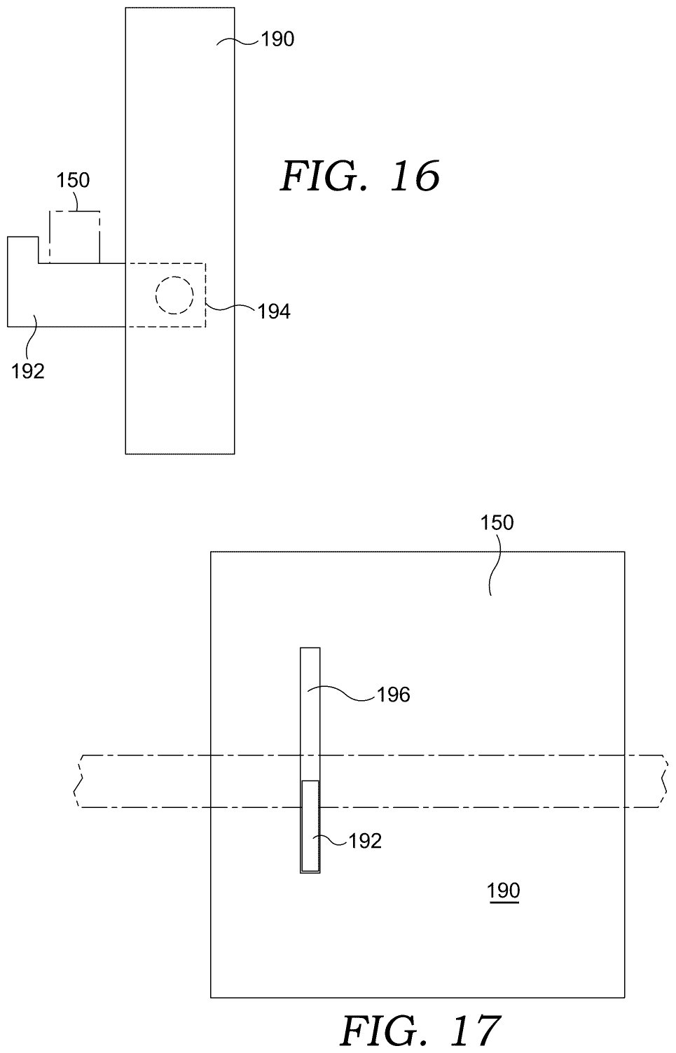

FIG. 16 depicts a side view of an alternative deck support assembly, in accordance with examples of this disclosure.

FIG. 17 depicts a front view of the alternative deck support assembly of FIG. 16, in accordance with examples of this disclosure.

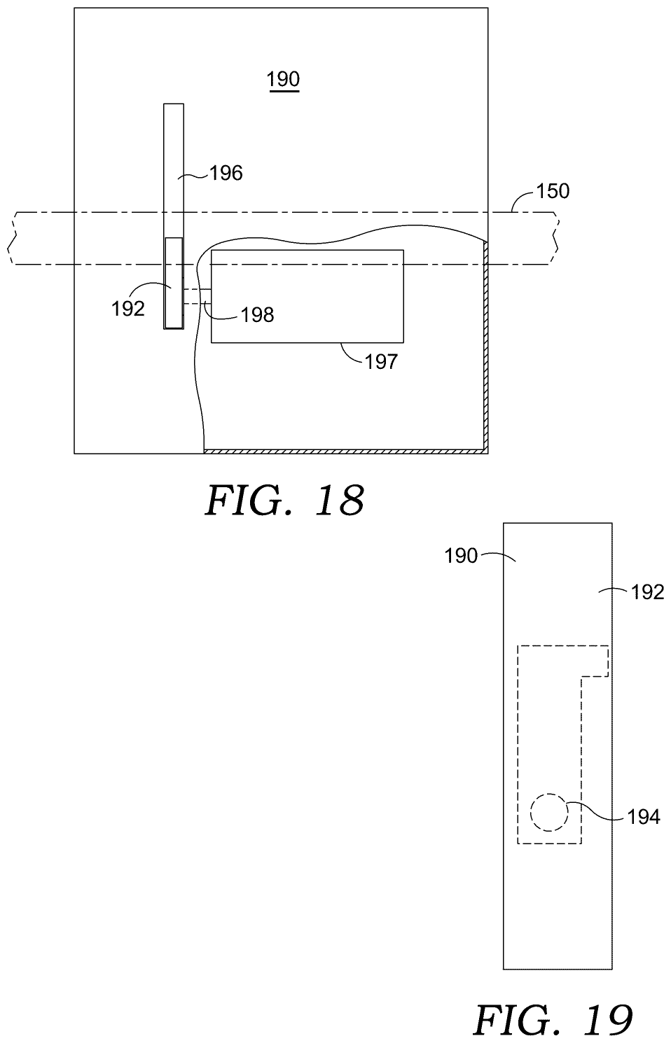

FIG. 18 depicts a front view of the alternative deck support assembly of FIG. 17 showing a cutaway view of control components of the alternative deck support assembly, in accordance with examples of this disclosure.

FIG. 19 depicts a side view of the alternative deck support assembly of FIG. 16 showing an alternative rotatable support truss in a closed position, in accordance with examples of this disclosure.

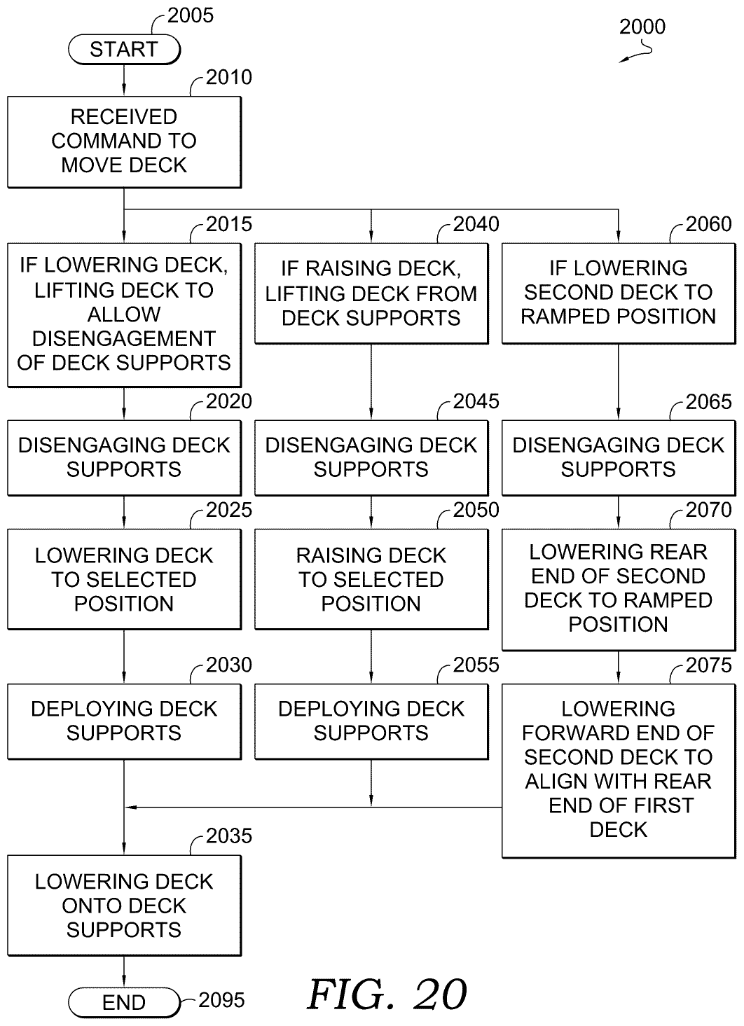

FIG. 20 depicts a flow diagram illustrating a method of raising, lowering and supporting components of an adjustable deck system, in accordance with examples of this disclosure.

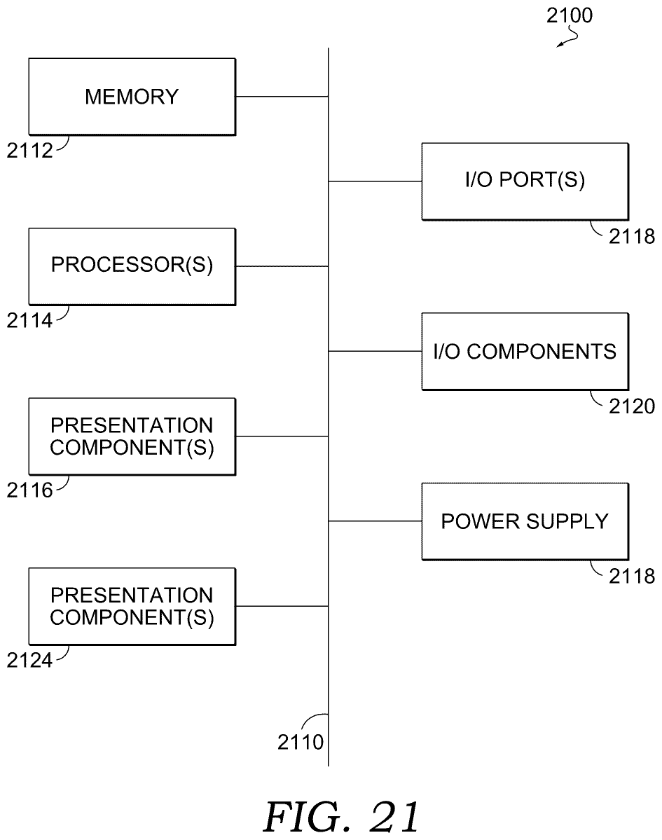

FIG. 21 is a simplified block diagram of a computing device with which examples of this disclosure may be practiced.

### DETAILED DESCRIPTION

This detailed description is related to a cargo vehicle with improved loading and unloading. At a high level, an adjustable deck system is disclosed for a cargo container of a cargo vehicle, and the adjustable deck system can be moved to various positions inside the cargo container to provide a second cargo loading deck or platform inside the cargo container. The adjustable deck system includes first and second decks that may be moved to and secured at various heights in the cargo container. The second deck is positioned at a rear portion of the cargo container, and a rear end of the second deck may be lowered from a raised position down to a floor position of the cargo container creating a ramp for loading cargo onto the first deck. Automated lift and support assemblies are provided for controlling movement and support of the adjustable deck system to and at various positions inside the cargo container.

With some conventional cargo vehicles (e.g., trucks), cargo compartments or containers are used for storing and transporting a variety of objects such as goods, materials, equipment, vehicles, waste materials, and the like. In the case of a tractor-trailer configuration, a cargo container may be permanently or temporarily affixed to a trailer chassis that is subsequently towed by a tractor vehicle. In the case of smaller transport vehicles, a cargo container may be permanently or temporarily affixed to a chassis of the smaller transport vehicle (e.g., truck). In either situation, cargo is typically loaded through an end or side access point and is placed and/or stacked on a floor surface of the cargo container.

In some situations, cargo may be stacked from a floor position of the cargo container to a full interior height of the cargo container. However, in other situations, cargo cannot be stacked owing to uneven top surfaces of cargo items or owing to potential damage that may occur by stacking. For example, stacking certain equipment items including mechanical systems (e.g., refrigeration units, generators, water pumps, etc.), small vehicles (e.g., tractors, golf carts, all-terrain vehicles, small cars, etc.), fragile materials (e.g., glass, ceramics, electronics, certain chemicals, etc.), and the like may cause damage to those items onto which other items are stacked. For another example, if a shipment of golf carts, recreational vehicles, construction vehicles, or the like is stacked on top of other such vehicles, the vehicles onto which other vehicles are stacked may be severely damaged. Unfortunately, being able to store and transport a single layer of items on a floor surface of the cargo container leaves an abundant amount of unused storage space in the cargo container which is very inefficient and costly use of the transport vehicle.

To address this problem, in some conventional systems, decking systems have been used in cargo containers to enable multiple layers of cargo to be carried in a single cargo load. Unfortunately, manual or partial automatic use of such systems is difficult for cargo transport operators as a lack of synchronization between systems for moving such decking systems into a desired position and systems for supporting such decking systems at a desired position makes use by operators difficult, cumbersome, and potentially dangerous.

In examples of the present disclosure, an adjustable deck system for a cargo container is provided. The adjustable deck system includes a first deck running from a forward interior wall of the cargo container to a position part way along a length of the cargo container (e.g., approximately three fourths the length of the cargo container). A second deck begins at the rear end of the first deck and runs to the end of the cargo container. The two decks combine to form the adjustable deck system that can be raised or lowered to various positions in the cargo container for allowing cargo to be stored and transported on two loading platforms. The rear end of the second deck can be lowered to a floor position of the cargo container to form a ramp for loading cargo onto the second deck.

According to some examples, the first deck can have a longitudinal support rail on each of first and second sides of the first deck. In addition, the second deck has a longitudinal support rail on each of first and second sides of the second deck. The second deck is adjustable between a horizontal orientation and a ramped orientation. According to one example, an automatic deck support system is included that automatically engages the longitudinal support rail on each of the first and second sides of the first and second decks when the first and second decks are adjusted to a position in the cargo container at which the automatic deck support system is located. In examples in which the automatic deck support system is not included for the first deck, the first deck may be manually adjusted by a user to a position in the cargo container.

The automatic deck support system includes a rotatable support truss that rotates automatically from a rest position coplanar and/or parallel with an inner wall of the cargo container to a position perpendicular to the inner wall and underneath the longitudinal support rail of each of first and second sides of the first and second decks. When the rotatable support truss system engages the underneath side of the longitudinal support rails, it provides robust support for the first and second decks.

According to examples, operation of the automatic deck support system for the first deck is synchronized with operation of the automatic deck support system for the second deck when the second deck is in a horizontal orientation. That is, while both the first and second decks are in a horizontal orientation, the automatic deck support system simultaneously deploys the rotatable support trusses for both decks which provides a solid continuous platform for storing and transporting cargo. On the other hand, when the second deck is lowered to a ramped orientation to allow for loading the first deck, the automatic deck support system operates separately for the first and second decks. When the first and second decks are both in horizontal orientation, the rotatable support trusses are also rotated and engaged simultaneously for both decks. However, when the second deck begins lowering to a ramped orientation, the automatic deck support system disengages from supporting the second deck to allow it to lower to the ramped orientation.

According to additional examples, the adjustable deck system includes an automatic deck lift system that automatically adjusts the height of the first and second decks to the position in the cargo container at which the automatic deck support system is located. The automatic deck lift system is synchronized with operation of the automatic deck support system for the first and second decks when the second deck is in a horizontal orientation. The automatic deck lift system operates independently for each of the first and second decks when the second deck is adjusted between the horizontal orientation and the ramped orientation. According to examples, the automatic deck lift system includes a lift motor, a lift chain that is operatively connected to the lift motor for allowing the lift motor to actuate the lift chain upward and downward, and a lift support connected to the lift chain.

The lift support is slidably positioned underneath the longitudinal support rail of each of the first and second sides of each of the first and second decks for lifting and lowering the first and second decks. In addition, the lift support is positioned to support a forward end of the second deck at a same level as a rear end of the first deck when the second deck is adjusted to a ramped orientation. According to one example, the lift support is adjustable to cause the forward end of the second deck to remain the same level as a rear end of the first deck when the second deck is adjusted to a ramped orientation. A lift support brace may be adapted to an inner wall of the cargo container for receiving the lift support and for preventing the lift support from moving lower than a position of the lift support brace.

These and other aspects are described further below with reference to the accompanying drawings. The drawings are merely example implementations, and should not be construed to limit the scope of the claims. For example, while the example vehicles are shown and described as being heavy-duty or medium-duty trucks, aspects described herein can be used with a variety of other vehicle sizes, classes, and types (e.g., light duty trucks and other passenger vehicles, buses, trams, carts, and the like). In addition, the subject matter of this disclosure can be used with internal combustion engine (“ICE”) vehicles, electric vehicles (“EV”), battery electric vehicles (“BEV”); hybrid electric vehicles (“HEV”), plug-in electric vehicles (“PHEV”), and with fuel-cell electric vehicles (“FCEV”), among others.

As used herein, the terms “about”, “approximately” and “substantially” mean+/−10% of a given value, such as a dimensional value (e.g., height, width, etc.). In addition, with respect to an angle, or the terms parallel and perpendicular, the terms “about” and “substantially” mean within 10 degrees. If “about” or “substantially” are otherwise used, the terms can, where appropriate, include equivalents of the modified element.

FIG. 1 depicts a perspective view of a cargo container 110 (e.g., a cargo trailer) and tractor combination showing a cargo container with an adjustable deck system, in accordance with examples of this disclosure. In FIG. 1, a trailer and tractor configuration is illustrated where the cargo container 110 is permanently or temporarily affixed to an underlying trailer that is towed by a tractor 105. As should be appreciated, the trailer and tractor configuration is for purposes of example only and is not limiting of other example configurations where the cargo container 110 may be permanently or temporarily affixed to the chassis of a smaller form vehicle, for example, a truck with the tractor 105 and cargo container 110 affixed to a single underlying chassis.

Referring still to FIG. 1, in examples of the present disclosure, a cargo container 110 or compartment for storing and transporting cargo includes an adjustable decking system 120 that runs longitudinally from a forward interior wall 112 of the cargo container 110 to a rear end 116 of the cargo container. According to examples, cargo may be loaded and unloaded through an access point (e.g., door) at the rear end 116, or cargo may be loaded via access points along one or both sides of the cargo container 110. As illustrated in FIG. 1, the adjustable decking system 120 may be raised inside the cargo container to provide a second layer or platform inside the cargo container for storing and/or transporting cargo 129. According to one example, the adjustable decking system is divided into two or more decks 122, 124. A first deck 122 of the adjustable decking system 120 is positioned, as compared to the second deck 124, more forward in the cargo container 110. For example, the first deck 122 can extend longitudinally at least partially between a forward interior wall 112 of the cargo container and a forward end 126 of the second deck 124. According to one example, the first deck 122 runs approximately three fourths or more of the interior length of the cargo container, but as should be appreciated, the first deck may run any number of other lengths inside the cargo container as required for one or more cargo situations. The second deck 124 begins at a rear end 123 of the first deck 122 and extends towards the rear end 116. For example, the second deck 124 can extend from the rear end 123 and run the remaining interior length of the cargo container 110.

According to examples, and as illustrated further in FIGS. 10, 11 and 13 below, at least the second deck (and possibly the first deck) includes an underlying structural framework including support rails 150 running longitudinally along first and second sides near the interior longitudinal walls 113, 114 of the cargo container 110. A plurality of cross support rails 152, 153 (see also FIGS. 10, 13) can extend between the longitudinal support rails between the interior longitudinal walls 113, 114 of the cargo container 110 such that a generally rectangular support structure for each of the first and second decks 122, 124 is formed. An overlying material such as steel, plywood, composite material, or other suitable material is affixed to an upper surface of the support structures of each of the first and second decks for forming first and second deck platforms onto which cargo may be stored and/or transported. According to examples of the present disclosure, both the first and second decks 122, 124 combine to form a horizontal deck 120 onto which cargo may be stored at various levels inside the cargo container.

Referring still to FIG. 1, according to examples, both the first and second decks 122, 124 may be moved up or down (e.g., simultaneously or independently) so that the combined adjustable decking system 120 comprised of the first and second decks 122, 124 forms a continuous platform running the interior length of the cargo compartment onto which cargo 129 may be stored and/or transported. By moving the adjustable decking system (first and second decks) up, otherwise unused space in the cargo container 110 may be loaded with cargo. As illustrated in FIG. 1, a row of example vehicles is loaded onto the adjustable decking system 120 allowing for utilization of the space above the first layer of cargo 129 loaded onto a floor surface 119 of the cargo container 110.

FIG. 2 depicts a perspective view of the cargo trailer and tractor combination of FIG. 1 showing the adjustable deck system in a fully raised position, in accordance with examples of this disclosure. In the raised position illustrated in FIG. 2, cargo 129 may be loaded onto the floor surface 119 of the cargo container 110 without hindrance created by the lowered adjustable deck system 120. After loading a first layer of cargo under the raised adjustable decking system, the adjustable decking system comprised of the first and second decks may be lowered to a position above the presently loaded cargo (see FIG. 1), and the adjustable decking system may then be loaded with another layer of cargo 129 which allows use of previously unused space in the cargo container 110 above the first layer of cargo. According to examples, one or more additional adjustable decking systems 120 may be included in the cargo container to allow for multiple decks for loading multiple layers of cargo.

FIG. 3 depicts a perspective view of the cargo trailer and tractor combination of FIG. 1 showing the adjustable deck system in a fully raised position and showing first and second cargo decks comprised of a plurality of independently adjustable deck sections, in accordance with examples of this disclosure. FIG. 4 depicts a perspective view of the cargo trailer and tractor combination of FIG. 3 showing the second deck lowered to a ramped orientation and showing the plurality of independently adjustable deck sections of the first deck positioned at different cargo levels inside the cargo trailer. According to the alternative examples illustrated in FIGS. 3 and 4, the first and second decks 122, 124 of the adjustable deck system 120 may be divided or sectioned into a plurality of sections 121, 128 that may be raised or lowered individually and independently of each other.

As illustrated in FIGS. 3 and 4, a plurality of deck sections 121 of the first deck 122 are shown that each may be individually and independently raised and lowered (e.g. using methods and devices discussed herein along with variations thereof) which allows the deck sections 121 to move up and down without necessarily requiring movement of the other deck sections 121 of the first deck. As should be appreciated, enabling raising and lowering of individual deck sections 121 of the first deck allows for loading and transporting cargo 129 of varying sizes. For example, referring to FIG. 4, an object that is too tall (e.g., a golf cart with attached roof) may be loaded under a given deck section 121 (e.g., the forward-most area of the cargo container 110), and the forward-most deck section 121 may be raised to a high position in the cargo container 110 to provide room for the high profile object to be loaded. Continuing with this example, to the immediate rear of the forward-most deck section 121, lower profile cargo may be loaded onto the floor level 119 and additional cargo may be loaded onto the raised deck section 121 to allow two layers of cargo.

In some examples, the height adjustment mechanism for each of the deck sections 121 can be similar to the height adjustment mechanism for the second deck 124. In some examples, the height adjustment mechanism for each of the deck sections 121 can be different from the height adjustment mechanism for the second deck 124. In some examples, the first deck 122 (or any of the sections 121) can attach to the side walls via a mechanism that does not permit height adjustment. For example, the first deck 122 (or any of the sections 121) can attach to the side walls at a fixed position or height.

Referring still to FIG. 4, the second deck 124 that forms a ramp at the rear end of the cargo container 110 (see FIGS. 4-6) may include a single deck section (e.g., sheet or panel) or can be segmented into two or more second deck sections 128 that may operate individually and independently from other second deck sections 128 comprising the second deck 124 (i.e., ramp deck). In addition, it is contemplated that the second deck 124 may involve more or less than the two deck sections 128. For example, if a relatively steep ramp is desired, one deck section 128 may be used to form the ramp. If a less steep ramp is desired, two or more deck sections 128 may be used to form the ramp. According to one example, any of the deck sections 121, 128 may be capable of being lowered to form a ramp structure at any suitable location within the cargo container 110. That is, any of the deck sections 121, 128 may be equipped for having a forward or rear end of the deck sections 121, 128 lower to allow the deck section 121, 128 to form a ramp for loading cargo to an adjacent deck section 121, 128.

The systems and functionality operable to raise, lower and support the adjustable deck system 120 including the first and second decks 122, 124 and individual deck sections 121, 128 are described in detail below. In addition, while the deck sections 121, 128 are depicted as being the same or similar sizes, it should be appreciated that the sizes of individual deck sections 121, 128 comprising the first and second decks 122, 124 may be varied to accommodate different shapes and sizes of cargo that will be transported in a given version of the cargo container 110. For example, it may be advantageous to optimize the size of the deck sections 128 comprising the second deck 124 such that the dimensions of the second deck 124 lowered to a ramped orientation are suitable for particular functions such as receiving wheeled vehicles.

According to examples of the present disclosure, both the first and second decks 122, 124 (and individual deck sections 121, 128) may be lowered to the floor surface 119 where the entire adjustable deck system 120 rests on (or directly above) the floor surface 119 as opposed to only the rear end of the second deck 124 being lowered to the floor surface 119 to place the second deck 124 in a ramped position. According to these examples, the entire adjustable deck system 120 or first or second decks 122, 124 or individual deck sections 121, 128 may be lowered and raised by lift assemblies (described below with reference to FIG. 8A) to enable use of the first and second decks 122, 124 or individual deck sections 121, 128 as elevator systems. That is, instead of lowering only the rear end 125 of the second deck 124 to the floor surface 119 to position the second deck 124 in a ramped position or orientation, the entire adjustable deck system or any of the individual decks or deck sections 121, 122, 124, 128 may be lowered individually or simultaneously to allow each or all of the individual decks or deck sections 121, 122, 124, 128 to be lowered and raised in a horizontal manner. Thus, an operator of the cargo container 110 may load cargo onto the first and second decks 122, 124 or onto the individual deck sections 121, 128 when they are lowered to the floor surface 119. Decks or deck sections 121, 122, 124, 128 may then be raised to a desired height/position such that the decks or deck sections operate as individual or combined cargo elevator systems. In some examples, the decks 121 and 122 might not be moveable. For example, decks 121 and 122 might be fixed in position and not movable via a powered or manual system.

FIGS. 4-6 depict perspective views of the second deck lowered to a ramped orientation, and FIGS. 7 and 8A depict a perspective view showing the second deck raised back to a horizontal orientation. According to one example, the second deck 124 may be lowered such that a forward end 126 of the second deck 124 remains at a same level as a rear end 123 of the first deck 122 and so that a rear end 125 (including optional ramp assist members 127) of the second deck lowers in a ramped orientation to a floor position in the cargo container. Once lowered, as described, the second deck 124 forms a ramp for loading cargo onto the first deck 122 while the first deck is maintained at a raised position above a first layer of cargo 129 positioned on a floor surface 119 of the cargo container 110. Accordingly, the second deck 124 is adjustable between a horizontal orientation and a ramped orientation.

In at least some examples, and referring to FIG. 8B, the rear portion of the second deck 124 can include ramp assist members 127 that can be adjusted between an “up” or “stowed” position and a “down” or “deployed” position. For example, referring to FIG. 8B, the ramp assist members 127 are shown in the down position, in which the ramp assist members 127 can provide a graduated sloped or ramped interface to assist with moving (e.g., rolling) cargo onto and/or off of the second deck 124. Some examples of the present disclosure can include a deck with the ramp assist members 127. The deck with the ramp assist members 127 can be used with or without other features described in this disclosure. For example, the deck can be installed with or without deck support assemblies and with or without the lift assemblies (e.g., 130 and 132).

In examples, the ramp assist members 127 can rotatably attach to the rear portion of the second deck 124, such that the ramp assist members 127 can be adjusted between the down position and the up position. For example, a slotted bracket 157 (e.g., bracket with multi-path slot) can be fixed to the rear of the second deck, and the ramp assist members 127 can include a protrusion 158 (e.g., post-like protrusion) engaged in the slot. The slot in the bracket can include a first segment that is oriented up/down (or vertically) and a second segment that is continuous with the first portion at a top end of the first portion and that is oriented forward/rearward (e.g., horizontal).

In examples, to move the optional ramp assist members from the down position (e.g., as shown in FIG. 8B) to the up position or stowed position, an operator can manually lift the ramp (e.g., slide the protrusion 158 upward in the vertical slot) and pull (e.g., slide) the ramp outward (e.g., slide the protrusion 158 outward in the forward/rearward slot). Then the operator can pivot or rotate the ramp upward, push (e.g., slide) the ramp forward (e.g., slide the protrusion 158 forward in the vertical slot), and drop the ramp downward to lock the ramp in the stowed/up orientation (e.g., the protrusion 158 falls along the vertical portion of the slot into a locked position). In the stowed/up orientation, the ramp assist member(s) 127 can operate as a stop to impede cargo from moving (e.g., sliding, rolling, gliding, etc.) toward the access opening of the cargo container 110. In examples, the ramp assist member(s) 127 can be moved from the up/stowed position to the down/deployed position by following a similar series of steps: lift (e.g., slide) the ramp assist member(s) 127 (e.g., protrusion 158) up in the slot (e.g., slide the protrusion 158 upward in the vertical slot); slide the ramp assist member(s) 127 (e.g., the protrusion 158) out in the slot (e.g., slide the protrusion 158 outward in the horizontal slot); rotate the ramp assist member(s) 127 down; slide the ramp assist member(s) 127 inward (e.g., in the top portion/segment of the slot); and slide the ramp down to lock it into the deployed position.

As illustrated in FIGS. 7 and 8A, after use of the ramp oriented second deck 124 for loading cargo onto the first deck 122, the second deck 124 may be raised back to a horizontal orientation. From a review of FIGS. 5-8B, it should be apparent that, when loading both the floor surface 119 and the adjustable deck system 120, the floor surface 119 may be partially loaded to leave room to lower the second deck 124 to the ramped orientation for loading the first deck 122. After the first deck is fully loaded, additional cargo may be moved onto the lowered second deck 124. The second deck 124 may then (e.g., while loaded with cargo) be raised back to a horizontal orientation (see FIGS. 7 and 8A) leaving the adjustable deck system comprised of the first and second decks 122, 124 filled with cargo as illustrated in FIG. 1. After the first and second decks 122, 124 are fully loaded and the second deck 124 is raised back to the horizontal orientation as illustrated in FIGS. 7 and 8A, the remaining empty space on the floor surface 119 left open to allow for the lowered second deck 124 may be filled with cargo so that both cargo surfaces (floor surface 119 and adjustable deck 120) are fully utilized. In some examples, the first and second decks 122, 124 may include edge guards to assist with holding any loaded cargo in place so that the loaded cargo does not interfere with components of the adjustable deck system 120.

FIG. 8A depicts a perspective view of a rear portion of the cargo container of FIG. 7 showing the second deck raised to a horizontal orientation and showing various components operative for raising, lowering and supporting the second deck, in accordance with examples of this disclosure. In some examples, while illustrated in FIG. 8A in association with the second deck 124, the components illustrated in FIG. 8A also are applicable to and are operative for raising, lowering and supporting the first deck 122 as illustrated in FIG. 8A. However, the first deck 122 can include a different mechanism or system for raising, lowering, and supporting the first deck 122. According to examples, the adjustable deck system (e.g., of the first and/or second decks) is raised and lowered with motorized lift assemblies comprised of components 130, 132, 160, 180 (see FIGS. 8A and 10). According to examples, each motorized lift assembly is comprised of a lift motor 130, a lift chain 132 and a movable deck lift support 160, 180 (see FIGS. 8A-14). According to one example, each motorized lift assembly is positioned along both interior longitudinal walls 113, 114 of the cargo container 110 to facilitate raising and lowering the adjustable deck system while maintaining the adjustable deck system in a level orientation as it moves vertically through various positions in the cargo container.

At various positions along the interior longitudinal walls of the cargo container 110, the lift motors 130 are mounted at or near the tops of the interior walls 113, 114 (see also FIGS. 1, 3, 14). According to examples, the operation of the lift motors 130 may be programmatically controlled based on preset positions in the cargo container 110 to which the first and second decks 122, 124 may be moved. According to one example, encoders associated with each lift motor 130 may be operative to provide positioning information to a computer processor 2100 (see FIG. 21) for allowing the processor 2100 to track movement and positioning of the components of the adjustable deck system 120. Additionally or alternatively, programmatic control may be based on data received from one or more sensors 188 (see FIG. 14) disposed in the cargo container 110 for detecting movement and positioning of the first and second decks 122, 124. As should be appreciated, any suitable sensor 188 may be utilized, for example, motion detectors, electric eyes, and the like. Alternatively, computer-controlled programming may be utilized to control operation of the deck lift assemblies 130,132,160,180 and deck support assemblies 140 when an operator selects a specified configuration of the first and second decks.

The chains 132 are operatively connected to the lift motors 130 and are configured to glide up and down the interior longitudinal walls of the cargo containers in lift tracks 164. The chains are affixed to movable deck lift supports 160, 180, described in detail below that similarly are configured to glide up and down in the interior longitudinal lift tracks 164 as the chains 132 are raised or lowered by corresponding lift motors 130. As should be appreciated, the chains 132 may be replaced with other suitable devices, such as belts, for connecting the lift motors 130 with deck lift supports 160, 180. According to examples, the movable deck lift supports 160, 180 support the first and second decks 122, 124 under longitudinal support rails 150 of the first and second decks. Actuation of the lift motors 130 for lifting the first and second decks 122, 124 causes the lift motors to pull the chains up which in turn pulls each associated movable deck lift support 160, 180. Pulling the chains 132 and movable deck lift supports 160, 180 up correspondingly lifts the first and second decks 122, 124 by raising the movable deck lift supports under the longitudinal support rails 150 of the first and second decks. Actuation of the lift motors for lowering the first and second decks causes the lift motors 130 to lower the chains 132 which in turn allows the deck lift supports to lower along with the first and second decks 122, 124 supported by the deck lift supports 160, 180.

According to examples, in order to lower the second deck 124 from a horizontal orientation to a ramped orientation to use the second deck 124 as a ramp for loading cargo onto the first deck 122, deck lift assemblies configured for raising and lowering the second deck 122 may be operated independently from deck lift assemblies configured for raising and lowering the first deck 122. Moreover, where more than one lift assembly is configured on each longitudinal side of the second deck 124 as may be required to raise and lower the second deck, the two or more lift assemblies configured on each longitudinal side of the second deck 124 (ramp deck) may be configured to automatically raise or lower at different rates to allow the rear end 125 of the second deck 124 to lower all the way down to the floor position of the cargo container 110 to place the second deck into the ramped orientation.

According to examples, operation of the deck lift assemblies may be automated and computer-controlled. As such, when both first and second decks 122, 124 are in a horizontal orientation, the deck lift assemblies may operate all lift motors 130, chains 132, and lift supports 160, 180 simultaneously to keep the adjustable deck system 120 balanced and level. However, when the second deck 124 is lowered to a ramped orientation, the deck lift assemblies for the first deck 122 and the second deck 124 will then operate independently given the different lifting and lowering requirements for the two decks 122, 124. In some examples, the first deck 122 may not be automated nor computer-controlled, and the deck lift assemblies for the first deck 122 (e.g., manually operated) and the second deck 124 (e.g., automated and computer-controlled) will similarly operate independently given the different lifting and lowering requirements for the two decks 122, 124.

Referring now to FIGS. 7-9, the deck lift support 160 is described in additional detail. According to examples of the present disclosure, the deck lift 160, illustrated in FIGS. 7-9 is operative for slidable or rollable contact with the longitudinal rails 150 serving as longitudinal support structures for the first and second decks 122, 124. While the deck lift support 160 is illustrated as supporting the second deck 124 as it is lowered to a ramped orientation and raised back to a horizontal orientation, the deck lift 160 may also be used for supporting the first deck 122 during raising and lowering motion. Referring to FIG. 9, the deck lift support 160 includes a support base 162 that may be coupled to an end of the chain 132 (see FIG. 8A). A chain coupling connector 169 fixed to the deck lift support base 162 may directly engage a link of the chain 132 via chain link 168. The deck lift support 160 may provide a connection between the first and second decks 122, 124 and an interior wall 113, 114 of the cargo container 110. For example, a track 164 may be fixed to the interior wall 113, 114 and sized to receive the deck lift support base 162. In the depicted example, outwardly extending protrusions 163 of the deck lift support base 162 are located within vertical-extending grooves defined by the track 164. While any suitable material is contemplated, in some examples, at least a portion of the deck lift support base 162 (such as at least the protrusions 163) may include a plastic material or other material that reduces friction to provide a smooth and consistent sliding motion of the deck lift support base 162 in the track 164. Additionally or alternatively, a lubrication may be applied to the deck lift support base to facilitate sliding in the track 164. Advantageously, the sliding support base 162 of the deck lift support 160 may be prevented from rotation or horizontal movement but may be allowed to slide vertically along the track 164 under the control of the chain 132 and lift motor 130, described above.

Referring still to FIG. 9, in the depicted example, a horizontal support member 166, which in this case is a roller bar or roller tube, extends from the deck lift support base 162 and provides vertical support for the first and second decks 122, 124 by engagement of the horizontal support member 166 with the longitudinal support rails 150 of the first and second decks 122, 124 (see also FIGS. 7, 8). Optionally, the horizontal support member 166 may directly connect to the deck lift support base 162 (i.e., via direct contact). According to one example, an opposite end of the horizontal support 166 may be coupled to a separate deck lift support 160 on the opposite interior wall of the cargo container 110. During movement (raising or lowering) of the adjustable deck system 120, the deck lift support 160 may control the vertical position of the horizontal support 166. That is, when the deck lift support 160 moves vertically, the horizontal support 166 also moves vertically causing movement of the first and second decks 122, 124 under which it is engaged. Typically, the longitudinal axis of the horizontal support 166 will remain horizontal throughout its movement, but it is not required in all circumstances. Optionally, the horizontal support 166 may be rotatable relative to the deck lift support base 162 about its longitudinal access, which may be particularly advantageous when the horizontal support 166 is fixed relative to the longitudinal support rails 150 of the first and second decks 122, 124. According to other examples, the horizontal support 166 may be substantially or completely fixed relative to the deck lift support base 162 (e.g., where the first or second decks 122, 124 may be rotatable/slidable relative to the horizontal support 166).

Referring now to FIGS. 10, 12-13, an alternative deck lift support 180 is described in additional detail. As illustrated in FIG. 10, the alternate deck lift support 180 may be used for supporting the first and second decks 122, 124 in similar fashion as deck lift support 160. That is, the alternate deck lift support 180 may be coupled to a chain 132 and may be slidably moved up and down in the track 164 to lift and lower the first and second decks 122, 124 by contacting (underneath) or attaching the second deck lift support 180 with/to the longitudinal support rails 150 of the first and second decks 122, 124. FIG. 12 depicts attachment of the alternate deck lift support 180 to support rail 150 via a roller/axle combination that allows the support rail 150 to rotate relative to the alternate deck lift support 180. The configuration depicted in FIGS. 12, 13 illustrate rotatable attachment of the alternate deck lift support 180 to a forward end 126 of the second deck 124.

According to this example configuration, the alternate deck lift support 180 may raise and lower the forward end 126 of the second deck 124 in concert with the associated lift motor 130 and chain 132, but importantly, the rotatable attachment depicted in FIGS. 12, 13 allows the alternate deck lift support 180 to maintain the forward end of the second deck 124 at a position adjacent to the rear end 123 of the first deck 122 while simultaneously allowing the rear end 125 of the second deck 124 to be lowered to the floor position of the cargo container 110 to place the second deck 124 into a ramped orientation as illustrated in FIGS. 3, 6.

According to examples of the disclosure, the alternate deck lift support 180, may operate in a similar fashion as the deck lift support 160, described above. Indeed, the alternate deck lift support 180 and the deck lift support 160 may be interchanged for serving the same purposes of lifting and lowering the first and second decks 122, 124. Referring to FIG. 12, in order to utilize the alternate deck lift support 180 as primary deck lift support or as an alternative to the deck lift support 160, the rotatable axle depicted as rotatably connecting the alternate deck lift support 180 to the support rail 150 via the connectors 185 and support rail orifice 184 is replaced with a horizontal support 166 as illustrated with the deck lift support 160 in FIG. 9. Engagement of the horizontal support 166 with an underside of the support rails 150 (see FIG. 8A) of the first and second decks 122, 124 allows the alternate deck lift support 180 to work in concert with the lift motor 130 and chain 132 to lift and/or lower the first and second decks 122, 124. Similar to the operation of the deck lift support 160 described above, movement of the alternate deck lift support 180 is facilitated by allowing the alternate deck lift support 180 to slide up and down in the track 164 via roller 182.

According to examples, the adjustable deck system 120 comprised of the first and second decks 122, 124 may be lowered all the way down to a floor position of the cargo container 110 and all the way up to a ceiling position of the cargo container 110. According to these examples, and as discussed in detail above, the adjustable deck system 120, including both the first and second decks 122, 124 and individual deck sections 121, 128 may operate as elevator systems where the entire deck 120 or sections of the first and second decks 122, 124 may be loaded at a floor position and then may be elevated vertically to one or more other positions in the cargo container 110. Alternatively, according to one example, the adjustable deck system 120 is configured to lower to a stop position (e.g., midpoint of cargo container interior walls) along the interior walls 113, 114 of the cargo container so that the adjustable deck system does not lower all the way to the floor position of the cargo container 110. Stopping the adjustable deck system 120 at a specific stop point leaves a first layer of the cargo container 110 open for cargo storage and/or transport. On the other hand, the adjustable deck system may be raised all the way to a top position at or near a ceiling of the cargo container 110 to allow the entire interior space of the cargo container 110 to be available for cargo storage and/or transport where the use of the adjustable deck system 120 is not needed for a given cargo situation.

Referring now to FIGS. 10 and 13, the present disclosure can include features that operate as additional stops or supports along the side wall 113. For example, referring to FIGS. 10 and 13, a lift support brace 186 can be affixed to the interior side walls 113, 114 at a selected height and positioned to engage a lift support (e.g., 160 or 180) when the lift support is lowered onto the lift brace support 186. In examples, the lift brace support 186 can include a plate or other structure (e.g., U-shaped plate with center cutout) as depicted in FIG. 13.

In at least some examples, a vertical position or height of the lift support brace 186 can be configured to increase the likelihood that a forward end 126 of the second deck 124 is relatively level with the rearward end 123 of the first deck 122, when the second deck 124 is in a ramped configuration. For instance, when the second deck 124 is moved to a ramped configuration (e.g., the forward end 126 includes a height similar to the first deck 122 and the rearward end 125 is lowered towards the floor surface 119), the lift support 180 can be supported on the upper edge of the lift support brace 186. In FIG. 13, the lift support 180 is shown spaced apart from the lift support brace 186 (for illustration purposes), and in operation the lift support 180 (e.g., the lower portion) can be supported directly on the upper edge of the lift support brace 186. In at least some examples, a vertical position of the lift support brace 186 is configured such that when the second deck 124 pivots on the lift support 180 and the forward end 126 raises and the rearward end 125 lowers, the forward end 126 is aligned with the rear end of the first deck.

These features, which contribute to a smooth transition between the first deck 122 and the second deck 124 can include various elements. For example, a vertical position of the lift support brace 186 contributes to the proper alignment of the forward end 126 with the rearward end 123. In at least one example, the vertical position of the lift support brace 186 is such that when the lift support 180 is supported directly on the lift support brace 186, the upper surface of the second deck 124 that is vertically aligned with the lift support 180 is below the upper surface of the second deck 122.

As described above, according one example, the second deck 124 may be lowered all the way to the floor surface 119 to enable use of the second deck 124 as an elevator system rather than as a ramp system. According to this example, the lift support brace 186, illustrated and described with respect to FIGS. 10, 13, may be removed to allow the second deck 124 to move up and down as an elevator system. For example, the lift support bracket 186 may be removable and/or retractable to allow both the second deck 124 to be lowered to the floor surface 119 and raised to the ceiling of the cargo container 110. In some examples, the lift support bracket 186 may be removably fastened to the interior side walls 113, 114 at a selected height along the interior side walls 113, 114. For example, the lift support bracket 186 may be removably fastened to the interior side walls 113, 114 using bolts, hooks, nails and screws, a quick connect, hanging rails, and/or any other method that could removably fasten the lift support bracket 186 to the interior side walls 113, 114. In some examples, the lift support bracket 186 may be selectively deployable along the interior side walls 113, 114. For example, the lift support bracket 186 may extend and/or rotate out from a stowed or resting position against an interior wall 113, 114 of the cargo container to a deployed position (e.g., either parallel to the interior wall if deployed or perpendicular to the interior wall if rotated). In some examples, the lift support bracket 186 may be manually or automatically deployed from a stowed position to a deployed position. For example, the lift support bracket 186 may be physically pulled (e.g., a folding plate) or rotated out (e.g., a swinging plate) from the stowed position into a deployed position. In some examples, the lift support bracket 186 may be operated automatically in association with a control unit, such as a motorized unit, for automatically actuating the lift support bracket 186 out from a stowed position to a deployed position. For example, the control unit may include an actuator for rotating the lift support bracket 186 about a rotation axle. According to examples, the actuator may be an electric motor, a pneumatic drive unit actuator operative to rotate the lift support bracket 186 using compressed air, or any other suitable actuator device or system, for example, a hydraulic system that moves the lift support bracket 186 using compressible fluids. In some examples, the lift support bracket 186 may not be included. In these examples, the chains 132 may be strong and robust enough to hold the second deck 124 in the ramped position, as well as the elevator system embodiment, without the lift support bracket 186.

Accordingly, in examples when the lift support bracket 186 is removed (e.g., unfastened) from the interior side walls 113, 114, is selectively deployable, and/or not included, the second deck 124 may convert between the ramped position to the elevator system. When the second deck 124 is acting as an elevator system, the second deck 124 may be lowered all the way on to the floor surface 119, such that the underside of the second deck 124 may touch the floor surface 119. When the second deck 124 is acting as an elevator system and is lowered to the floor surface 119, cargo may be placed on the second deck 124, and the second deck 14 may be raised to a desired position within the cargo container 110. If there is no cargo on the second deck 124, the second deck 124 may be raised to the ceiling of the cargo container 110. As such, the second deck 124 may be raised, lowered and supported with the deck lift assemblies 130,132,160,180 and deck support assemblies 140 (described in detail below).

FIG. 11 depicts a forward view of a portion of the first deck of the adjustable deck system of FIG. 1 showing alternative components operative for raising, lowering and supporting the first deck or sections of the first deck of the adjustable deck system, in accordance with examples of this disclosure. For example, the alternative components can be part of a non-motorized system for raising, lowering, and supporting a deck. As described above, the first and second decks 122, 124 may be raised, lowered and supported by the motorized lift assemblies, described above, comprised of components 130, 132, 160, 180 (see FIGS. 9 and 10). According to an alternative example, the first deck 122 may be raised, lowered and supported independently of the second deck 124. According to this alternative example, the first deck 122 may be configured to be positioned at a stop position forming a second loading layer, as illustrated in FIG. 1, and to be positioned at a raised or home position at or near the top of the cargo container 110, as illustrated in FIG. 2. Referring to FIG. 11, according to this example, the first deck 122 may be raised between a stopped position (e.g., loading position) and a raised or home position (see FIG. 2) by one or more cross rails or beams 153 affixed underneath the first deck 122 and any of the individual deck sections 121 comprising the first deck 122. According to this example, a lift support 160, 180 may be operatively affixed to or associated with the ends of the cross rail or beam 153 for lifting and lowering the cross rail 153 and first deck 122 (or first deck section 121). As should be appreciated, the lift supports 160, 180 may be rigidly attached to the cross rail 153 (similar to illustration in FIG. 12), or the lift supports 160, 180 may engage an underside of the cross rail 153 (similar to illustration in FIG. 9). As described above, according to one example, the lift supports 160, 180 may be raised and lowered with chains 132 and lift motors 130.

If the first deck 122 or a given first deck section 121 is configured to stop at a designated stopped position (see FIG. 1) where the first deck or the given first deck section 121 is not configured to lower beneath the designated stop position, a support structure, such as a lift support brace 186, described above, may be affixed to the interior walls 113, 114 for engaging the lift supports 160, 180 at the stop position and for supporting the loading of the first deck 122 (or individual first deck section 121) and any cargo loading placed on the first deck 122 or individual first deck section 121. Alternatively, if the first deck 122 and any deck sections 121 of the first deck 122 are configured to be positioned at a number of different heights/levels in the cargo container 110, then the first deck 122 and any deck sections 121 of the first deck 122 may be supported at different heights/levels by one or more deck support assemblies 140 described below. Referring now to FIGS. 13-15, as described above, according to some examples of the present disclosure, the adjustable deck system 120 may be configured to allow both the first and second decks 122, 124 to stop at various positions from a floor position of the cargo container 110 to a ceiling position of the cargo container to facilitate use of the adjustable deck system 120 according to different types of cargo 129. For example, one type of cargo loading may require substantially more space below the adjustable deck system 120 than on top of the adjustable deck system while another type of cargo 129 may require less space below the adjustable deck system. Alternatively, as described above, the first deck 122 may be configured to be loaded at a designated stop position and may be configured to be raised to a raised or home position (see FIG. 2). If either or both the first and second decks 122, 124 are configured to stop and to be supported at various heights/levels in the cargo container 110, then at each position at which one or both of the first and second decks 122, 124 are configured to stop and to bear loading, a plurality of deck support assemblies 140 may be configured to automatically engage longitudinal railing 150 underneath the first and second decks 122, 124 to support the first and second decks and cargo loaded thereon at a stationary and robustly supported position.

According to examples, the deck support assemblies 140 include a rotatable support truss (support) 142 rotatably coupled to the interior wall 113, 114 and operative to support the loading of the first and second decks 122, 124 and any cargo loaded thereon. According to examples, the rotatable support trusses 142 may be operated manually or automatically in association with a control unit for manually or automatically actuating the motorized rotatable support trusses out from a stowed or resting position (FIGS. 14, 15) against an interior wall 113, 114 of the cargo container to a deployed position (FIG. 13) perpendicular to the interior wall for engaging a bottom surface of support railing 150 of the first and second decks 122, 124. As illustrated in FIG. 15, the control unit includes an actuator 144 for rotating the rotatable truss 142 (support) about a rotation axle 143. According to examples, the actuator 144 may be an electric motor, a pneumatic drive unit actuator operative to rotate the support 142 using compressed air, or any other suitable actuator device or system, for example, a hydraulic system that moves the rotatable support trusses 142 using compressible fluids. According to one example, the actuator 144 is operatively connected to the rotation axle 143 via a motor pulley or gear 146, a chain or belt 147, and an axle pulley or gear 145. One or more control circuits 148 are provided for controlling actuation of the rotatable support truss either manually or automatically. According to one example, each rotatable support truss 142 is equipped with one or more limit switches operative to indicate whether the rotatable support truss is in a stowed position, a deployed position, or whether the rotatable support truss 142 is in motion between a stowed position and a deployed position. According to examples, indication of positioning of the rotatable support truss 142 may be utilized by a computer processor 2100 (see FIG. 21) for enabling programmatic control of the rotatable support trusses 142. As should be appreciated, if desired, any given deck support assembly 140 may be operated manually if required by an operator of the adjustable deck system 120.

According to examples, in order for the deck support assemblies 140 to engage the adjustable deck system, rotatable support trusses 142 of each of the deck support assemblies manually or automatically rotate out from a stowed or resting position to a deployed position perpendicular to an inner wall surface of the cargo container 110. According to at least one example, as the first and second decks 122, 124 are raised above the position of a deck support assembly 140 or lowered to the position of a deck support assembly 140, the first and second decks are stopped such that the underlying longitudinal support railings 150 are sufficiently higher than the deck support assemblies 140 to allow the rotatable support trusses 142 to deploy. The raising or lowering adjustable deck system (first and second decks 122, 124) is then manually or automatically lowered such that longitudinal railings 150 underneath the first and second decks 122, 124 come to rest on the deployed rotatable support trusses 142 as illustrated in FIG. 13.

As the adjustable deck system 120 raises and lowers through the interior height of the cargo container 110, the rotatable support trusses 142 of each of the deck support assemblies 140 may stay in a rest position with the rotatable support trusses rotated toward or against the interior walls 113, 114 of the cargo container 110 to allow the longitudinal sides of raising or lowering first and second decks 122, 124 to glide past the deck support assemblies 140 with their rotatable support trusses 142 rotated against the interior walls 113, 114 of the cargo container. Alternatively, as the adjustable deck system 120 raises and lowers, rotatable support trusses 142 that are not presently engaged in support of one or both of the first and second decks 122, 124 may remain in a deployed position as a safety measure to prevent one or both of the first and second decks 122, 124 from erroneously or accidentally moving below or above the deployed rotatable support trusses 142 until directed to do so. After the first and second decks 122, 124 are secured and supported on the deployed rotatable support trusses 142, cargo may then be loaded onto the adjustable deck system for storage and/or transport.

As described above for the deck lift assemblies, the deck support assemblies 140 associated with the second deck 124 may operate independently of the deck support assemblies 140 associated with the first deck 122 to allow the rear end 125 of the second deck 124 to be lowered to a ramped orientation as illustrated in FIG. 6. That is, when the second deck 124 is lowered to a ramped orientation, the deck support assemblies 140 disengage the rotatable support trusses 142 from the support railing 150 of the second deck to allow the rear end 125 of the second deck to lower to the ramped orientation while the rotatable support trusses supporting the first deck 122 remain deployed to support the first deck in any cargo loaded thereon. When the second deck 124 is raised back from the ramped orientation to a horizontal orientation, the rotatable support trusses 142 of the deck support assemblies 140 associated with the second deck may be deployed to support the second deck at the horizontal position as illustrated in FIG. 7. In the case of automated operation of the deck support assemblies 140, when both the first and second decks 122, 124 are in a horizontal orientation, the deck support assemblies 140 operate simultaneously across both decks. However, when the second deck 124 begins to lower toward a ramped orientation, the automated operation of the deck support assemblies 140 operate independently between the first and second decks 122, 124.

FIGS. 16-19 depict an alternative deck support assembly, in accordance with examples of this disclosure. As illustrated in FIG. 16, an alternative deck support assembly 190 is provided. The alternative deck support assembly 190 includes an alternative rotatable support truss 192 that rotates from a closed upward vertical position (FIG. 19) to a position perpendicular to the alternative deck support assembly 190 for supporting a longitudinal support rail 150 of the first and second decks 122, 124. According to examples, the alternative deck support assembly 190 illustrated in FIG. 16 provides for a rotatable support truss 192 that rotates vertically as opposed to horizontally as described above for the deck support assembly 140 and rotatable support truss 142. As illustrated in FIG. 17, a rotatable support truss slot 196 is provided for allowing the rotatable support truss 192 to disengage from the perpendicular support orientation, illustrated in FIG. 16, and to collapse into the alternative deck support assembly 190, as illustrated in FIG. 19. As illustrated in FIG. 18, the alternative deck support assembly 190 includes an actuator 197 (e.g., an electric motor, pneumatic actuator, hydraulic actuator, etc.) operatively coupled to the alternative rotatable support truss 192 via a drive axle 198 for rotating the alternative rotatable support truss 192 from a closed position, as illustrated in FIG. 19 to an open perpendicular position, as illustrated in FIG. 16.

According to examples, the alternative deck support assembly 190 operates in a similar manner as the deck support assembly 140, described above. That is, in order to support first and second decks 122, 124, the alternative rotatable support truss 192 is manually or automatically moved from a closed position, as illustrated in FIG. 19, to an open position perpendicular to the inner interior wall(s) 113, 114 of the cargo container 110 to allow the longitudinal support railing 150 of the first and second decks 122, 124 to be supported on the deployed alternative rotatable support truss 192, as illustrated in FIG. 16. When the first and/or second decks 122, 124 are raised or lowered such that the first and/or second decks 122, 124 need to move past the alternative deck support assembly 190, the alternative rotatable support truss 192 is closed into the slot 196, as illustrated in FIG. 19, to allow the moving first and/or second decks 122, 124 to glide past the disengaged alternative deck support assembly 190.

According to examples, the systems configured for raising, lowering and supporting the adjustable deck system 120 may be automated and may be synchronized with each other for smooth and efficient operation. That is, the deck lift assemblies 130, 132, 160,180 and the deck support assemblies 140 (e.g., including the alternative deck support assembly 190) may be synchronized and computer-controlled to work in concert when the adjustable deck system 120 is in motion. For example, when the deck lift assemblies 130, 132, 160,180 are actuated to lift or lower the adjustable deck system 120, the deck support assemblies 140 may be automatically actuated to deploy or close the rotatable support trusses 142 as required to either allow the adjustable deck system 120 to go up or down or to allow the adjustable deck system 120 to come to a rest on deployed rotatable support trusses.

According to one example, when the adjustable deck system 120 is in an upward motion, after the railing of the first and second decks 122, 124 disengage from deployed rotatable support trusses 142 of the deck support assemblies 140, those rotatable support trusses 142 may automatically be rotated to a home position (FIG. 15) against the interior walls 113, 114 of the cargo container to allow the adjustable deck system 120 to glide past those rotatable support trusses 142 as required for movement of the adjustable deck system 120. When the first and second decks 122, 124 of the adjustable deck system 120 are moved to a desired position in the cargo container, the underlying support railing may be automatically moved a distance above the deck support assemblies 140 that will subsequently be used for supporting the moved adjustable deck system 120. After the underlying railing of the first and second decks clear the deck support assemblies 140 at which the first and second decks 122, 124 are to be supported for receiving cargo, the rotatable support trusses 142 of those deck support assemblies 140 may be automatically rotated out to perpendicular orientations from the interior walls 113, 114 of the cargo container. The first and second decks 122, 124 may then be automatically lowered until the underlying support railings 150 of the first and second decks 122, 124 engage the deployed rotatable support trusses 142. The first and second decks 122, 124 may then be utilized for receiving cargo. According to another example, when the second deck 124 is lowered to a ramped orientation, the rotatable support trusses 142 supporting the second deck 124 may be automatically disengaged while the rotatable support trusses 142 engaged for the first deck 122 remain engaged to support the first deck 122 for cargo loading.

For operation of the second deck 124 as a cargo ramp, the systems described herein similarly may be automated and synchronized. For example, if an operator selects to have the second deck 124 lower to a ramped orientation, the deck lift assemblies 130, 132, 160, 180 may automatically engage to begin lowering the rear end 125 of the second deck 124 to a ramped orientation. In synchronized operation, the deck support assemblies 140 engaged for supporting the second deck 124 in a horizontal orientation may automatically disengage the rotatable support trusses 142 to allow the second deck 124 to glide past disengaged and closed rotatable support trusses 142 as the second deck 124 lowers to the ramped orientation. For example, in FIG. 13, the support truss 142 is depicted deployed, and upon receiving a signal to transition to a ramp configuration, the second deck 124 can be raised enough to retract the support truss 142, at which time the second deck 124 can be lowered to engage the lift support bracket 186 and to subsequently lower the rear end 125 towards the floor surface 119. If the operator subsequently selects to have the second deck 124 raise back to a horizontal orientation after the adjustable deck system 120 is loaded, the deck lift assemblies may automatically raise the rear end 125 of the second deck 124 to a horizontal position, and the deck support assemblies may automatically deploy rotatable trusses 142 to support the second deck 142 at the horizontal orientation position.

Movement of the first and second decks 122, 124 and deployment of deck support assemblies 140 may be detected and controlled programmatically. According to examples, encoders associated with lift motors 130, limit switches associated with rotatable support trusses 142, one or more sensors 188, and preset positioning data for components of the adjustable deck system 120 may enable a computer processor 2100 (see FIG. 21) to constantly track and control movement and positioning of the adjustable deck system 120.

For example, if an operator selects the second deck 124 to lower to a ramped orientation, programmatic control (via computer 2100 illustrated and described below with reference to FIG. 21) of the lift assemblies and deck support assemblies may cause the second deck 124 to automatically lift enough to disengage underlying support trusses 142, followed by automatic lowering of the second deck 124 and engagement of one or more support trusses 142 with the second deck 124 after it is lowered to the desired ramped position. For another example, if all cargo has been unloaded from the adjustable deck system 120 and the second deck 124 is presently lowered to a ramped position, an operator of the cargo container 110 may desire to raise both the first and second decks 122, 124 to a home position at or near the ceiling of the cargo container 110, as illustrated in FIG. 2. According to this example, after the operator selects that both the first and second decks 122, 124 are to be raised to the home position, as illustrated in FIG. 2, the deck support assemblies 140 presently engaging the second (ramped) deck 124 will be automatically disengaged as the second deck 124 raises back to a horizontal orientation, as illustrated in FIG. 7. After the second deck 124 is raised back to a horizontal orientation, the entire adjustable deck system 120 (comprised of first and second decks 122, 124) may then be automatically raised to the home position, as illustrated in FIG. 2. As the first and second decks 122, 124 move through the cargo container 110 toward the home position, the deck support assemblies 140 may be automatically actuated to rotate the rotatable support trusses 142 against the interior walls 113, 114 to allow the longitudinal railing 150 of the first and second decks 122, 124 to pass. Once the first and second decks 122, 124 reach a desired or programmed stopping position, deck support assemblies 140 may automatically engage the railing 150 of the first and second decks 122, 124 to support the first and second decks 122, 124 at the new position. As should be appreciated, these are but examples of the programmatic control of the adjustable deck system 120 and are not limiting of a number of different programmatic or automatic movements and positioning of the adjustable deck system 120 that may be performed according to examples of the present disclosure.

According to other examples, system automation may also provide safety benefits. For example, if a sudden movement of one or more of the first or second decks 122, 124 is detected either programmatically or via one or more sensors 188 such as the collapse of a portion of one or more of the first or second decks 122, 124, rotatable support trusses 142 beneath the present position of the moving deck may be automatically deployed to prevent the moving deck from falling onto personnel working below or onto cargo stored below. For another example, if an attempt to move the adjustable deck system 120 up or down in a manner that would cause the first and/or second decks 122, 124 or cargo loaded thereon to collide with a person or cargo, programmatic detection, for example via one or more sensors 188, may detect the potential collision and action may be automatically directed to prevent the collision such as automatic raising or lowering of the first and/or second decks 122, 124 and/or automatic deployment of rotatable support trusses 142. According to one example, as the first and second decks 122, 124 are moving upward or downward in the cargo container 110, the rotatable support trusses 142 are opened or closed in synchronized movement. For example, when the first or second deck 122, 124 reaches a position where the rotatable support trusses 142 deploy and engage the railing 150 of the decks 122, 124, rotatable support trusses 142 positioned below the current deck position may automatically deploy as safety catches that would catch the first and/or second decks 122, 124 in the event of a failure that would allow the first and/or second decks 122, 124 to fall from the presently supported position. Alternatively, as described above, the rotatable support trusses 142 may be maintained in deployed positions as the components of the adjustable deck system 120 move in the cargo container 110, and may only be stowed as required to allow a given deck 122, 124 to pass by a stowed rotatable support truss.

Referring back to FIGS. 6, 7, a control console 131 is illustrated near the back of the cargo container 110 for allowing operator access to and control over the adjustable deck system 120. Alternatively, a remote pendulum-type controller 133 is illustrated and disposed in the interior of the cargo container 110 for allowing the operator access to and control over the adjustable deck system. As should be appreciated, a wireless remote controller 133 or wireless application operated on a mobile telephone or other computing device similarly may be enabled to access and operate the programmatic controls of the adjustable deck system 120, as described herein. Use of a pendulum-type controller 133 or a wireless controller are particularly useful to allow an operator to operate components of the adjustable deck system 120 from a ground or dock level for loading and unloading the cargo container 110.

FIG. 20 depicts a flow diagram illustrating a method of raising, lowering and supporting components of an adjustable deck system, in accordance with examples of this disclosure. The method 2000 begins at start step 2005 and proceeds to step 2010 where a command is received to move the first or second decks 122, 124. As described above, the first and second decks 122, 124 of the adjustable deck system 120 may be moved inside the cargo container 110 by computer-control or manually. For purposes of example, consider that at step 2010, a command is received via the system control units 131 or 133 (see FIG. 6) by an operator of the adjustable deck system 120 for moving one or both of the first and second decks 122, 124, as described herein.

At operation 2015, if the command received at operation 2010 is a command for lowering one or both of the first and second decks 122, 124, the deck to be lowered is lifted slightly to allow disengagement of the rotatable support trusses 142 presently engaged under the railing 150 of the deck to be moved. At operation 2020, the disengaged rotatable support trusses 142 are rotated to a closed position against an interior wall 113, 114 of the cargo container 110 to allow the lowering deck to pass by the disengaged and closed rotatable support trusses 142. According to an example, as the lowering deck is lowered inside the cargo container 110, all rotatable support trusses 142 by which the deck may pass during its movement are automatically collapsed to closed or stowed positions against the interior wall 113, 114 of the cargo container 110.

At operation 2025, the deck to be lowered is lowered to a selected position. That is, the deck is lowered to a position selected by the operator at operation 2010. At operation 2030, rotatable support trusses 142 at the selected lowered position are deployed to position perpendicular to the interior wall 113, 114 underneath the lowering deck. At operation 2035, the lowering deck is lowered such that deck rails 150 of the lowering deck engage the deployed deck support trusses 142.

Referring back to operation 2010, if the command received to move one or both of the decks 122, 124 is a command for raising one or both decks, the method 2000 proceeds to operation 2040 where the deck or decks to be raised are lifted from underlying rotatable support trusses 142. At operation 2045, the rotatable support trusses 142 are disengaged and are collapsed to a closed or stowed position against the interior walls 113, 114 to allow the lifting deck to pass by the closed rotatable support trusses 142. According to an example, as the raising deck is lifted inside the cargo container 110, all rotatable support trusses 142 by which the deck may pass during its movement are automatically collapsed to closed positions against the interior wall 113, 114 of the cargo container 110. At operation 2050, the deck to be raised is lifted to a position selected by the operator at operation 2010.

At operation 2055, rotatable support trusses 142 are deployed underneath the deck that has been moved to a position slightly above the selected movement position, and at operation 2035, the deck is lowered onto the deployed rotatable support trusses 142.

Referring back to operation 2010, if the command received by the operator of the cargo container 110 is a command for lowering the second deck 124 to a ramped position, as described above, the method proceeds to operation 2065, and the rotatable support trusses 142 presently supporting the second deck 124 are disengaged. As described above, disengagement of the rotatable support trusses 142 includes temporarily and slightly raising the second deck 124 from the rotatable support trusses 142 to allow the rotatable support trusses 142 to disengage and collapse to a closed or stowed position against the interior walls 113, 114 of the cargo container 110.

At operation 2070, the rear end of the second deck 124 is lowered to a ramped position, as illustrated and described above. At operation 2075, the forward end 126 of the second deck 124 is lowered to align with the rear end 123 of the first deck 122 to provide a smooth transition between the surface of the first deck 122 and the surface of the forward end 126 of the now lowered second deck 124. The method 2000 then proceeds to operation 2035, and the lowering second deck 124 is lowered onto rotatable support trusses 142 deployed for supporting the second deck 124 in the ramped position, as illustrated in FIG. 6.

As described above, before, during, and after movement of either or both of the decks 122, 124 comprising the adjustable deck system 120, one or more safety measures may be automatically engaged. For example, as one or both of the decks 122, 124 are raising or lowering inside the cargo container 110, the rotatable support trusses 142 may operate in a synchronized manner to provide support against an inadvertent collapse of one or more of the decks 122, 124. That is, when one or more rotatable support trusses 142 are deployed, rotatable support trusses 142 beneath and above the present position of the decks 122, 124 are deployed to provide for a safety catch for catching the decks 122, 124 in the event of an erroneous downward movement, or for blocking an upward movement of the decks 122, 124 in the event of an erroneous upward movement. After all movement of the adjustable deck system 120 is performed, the method 2000 ends at operation 2095.

In some examples, in the event of an error while lowering and/or raising the adjustable deck system, the adjustable deck system may produce audible sounds to inform a user that an error has occurred. For example, if one of the rotatable support trusses 142 does not disengage after being deployed (e.g., does not rotated to a closed position against the interior wall 113, 114 of the cargo container 110) while the adjustable deck system is moving to a raised position, a fault light may turn on and an audible beep noise my begin sounding off, indicating an error or a fault logged in the system. In such an example, if the user is aware of the error or fault, the user may attempt to correct the error or fault. In some examples, if the user not aware of the error or fault, the user may try to complete the operation a second time. In this example, if the user tries to complete the operation a third time but the error/fault is still active, the fault light may change to a blinking red light and the audible beep noise begins to sound off quicker than before, which indicates the system is locked out and that the motion cannot continue. Under these circumstances, the user should call service/maintenance and/or review the user guide to resolve possible issues with the adjustable deck system. In some examples, the system will time out after a certain period of time (e.g., 20 minutes), and the user may try again to complete the operation (e.g., up until three tries before the system is locked out again).

FIG. 21 is a simplified block diagram of a computing device/system with which examples of this disclosure may be practiced. As described above, movement of the components of the adjustable deck system 120 may be performed manually or by computer control. The computing device/system 2100 illustrated in FIG. 21 represents a suitable operating environment in which computer control of the adjustable deck system 120 may be operated. Aspects of the present disclosure may be described in the general context of computer code or machine-useable instructions, including computer-executable instructions, such as program modules, being executed by a computer or other machine, such as a personal data assistant or other handheld device. Generally, program modules including routines, programs, objects, components, data structures, etc., refer to code that perform particular tasks or implement particular abstract data types. Aspects of the present disclosure may be practiced in a variety of system configurations, including hand-held devices, consumer electronics, general-purpose computers, more specialty computing devices, etc. Aspects of the present disclosure may also be practiced in distributed computing environments where tasks are performed by remote-processing devices that are linked through a communications network.

With reference to FIG. 21, the computing device 2100 includes a bus 2110 that directly or indirectly couples the following devices: a memory 2112, one or more processor(s) 2114, one or more presentation component(s) 2116, input/output (I/O) port(s) 2118, input/output components 2120, an illustrative power supply 2122, and radio(s) 2124. The bus 2110 represents what may be one or more busses (such as an address bus, a data bus, or a combination thereof). Although various blocks of FIG. 21 are shown with lines for the sake of clarity, in reality, delineating various components is not so clear, and metaphorically, the lines would more accurately be grey and fuzzy. For example, one may consider a presentation component, such as a display device, to be an I/O component. Also, processors have memory. The inventor recognizes that such is the nature of the art and reiterates that the diagram of FIG. 21 is merely illustrative of an exemplary computing device that can be used in connection with one or more embodiments of the present disclosure. Distinction is not made between such categories as “workstation,” “server,” “laptop,” “hand-held device,” etc., as all are contemplated within the scope of FIG. 21 and with reference to the term “computing device.”

The computing device 2100 typically includes a variety of computer-readable media. The computer-readable media can be any available media that can be accessed by the computing device 2100 and includes both volatile and nonvolatile media, and removable and non-removable media. By way of non-limiting example, the computer-readable media may comprise computer storage media and communication media. The computer storage media includes both volatile and nonvolatile, removable, and non-removable media implemented in any method or technology for storage of information, such as computer-readable instructions, data structures, program modules or other data. The computer storage media includes, but is not limited to, random-access memory (RAM), read-only memory (ROM), electronically erasable programmable read-only memory (EEPROM), flash memory or other memory technology, compact disc read-only memory (CD-ROM), digital versatile disks (DVDs) or other optical disk storage, magnetic cassettes, magnetic tape, magnetic disk storage or other magnetic storage devices, or any other medium which can be used to store the desired information and which can be accessed by the computing device 2100. The computer storage media does not comprise signals per se. The communication media typically embodies computer-readable instructions, data structures, program modules or other data in a modulated data signal, such as a carrier wave or other transport mechanism, and includes any information delivery media. The term “modulated data signal” means a signal that has one or more of its characteristics set or changed in such a manner as to encode information in the signal. By way of non-limiting example, the communication media includes wired media, such as a wired network or direct-wired connection, and wireless media, such as acoustic, RF, infrared and other wireless media. Combinations of any of the above should also be included within the scope of computer-readable media.

The memory 2112 includes computer-storage media in the form of volatile and/or nonvolatile memory. The memory 2112 may be removable, non-removable, or a combination thereof. Exemplary hardware devices include solid-state memory, hard drives, optical-disc drives, etc. The computing device 2100 includes one or more processor(s) 2114 that read data from various entities such as the memory 2112 or the I/O components 2120. The presentation component(s) 2116 present data indications to the user or other device. Exemplary presentation component(s) 2116 include a display device, a speaker, a printing component, a vibrating component, etc.

The I/O port(s) 2118 allow the computing device 2100 to be logically coupled to other devices including the I/O components 2120, some of which may be built in. Illustrative components include a microphone, a joystick, a game pad, a satellite dish, a scanner, a printer, a wireless device, etc. The I/O components 2120 may provide a natural user interface (NUI) that processes air gestures, voice, or other physiological inputs generated by the user. In some instances, inputs may be transmitted to an appropriate network element for further processing. The NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 2100. The computing device 2100 may be equipped with depth cameras, such as stereoscopic camera systems, infrared camera systems, RGB camera systems, touchscreen technology, and combinations of these, for gesture detection and recognition. Additionally, the computing device 2100 may be equipped with accelerometers or gyroscopes that enable detection of motion. An output of the accelerometers or the gyroscopes may be provided to the display of the computing device 2100 to render immersive augmented reality or virtual reality.

### Example Clauses

A. An adjustable deck system for a cargo container, the adjustable deck system comprising: a deck comprising a forward end oriented towards a front of the cargo container and a rearward end oriented towards a rear of the cargo container; a deck lift system that adjusts a vertical position of the rearward end to convert the deck between a horizontal orientation and a ramped orientation; and an automatic deck support comprising: a support that is rotatably coupled to a wall of the cargo container; and an actuator that rotates the support between a stowed position, which is vertically offset from the deck, and a deployed position which is vertically aligned with the deck.

B. The adjustable deck system of Clause A, further comprising the deck lift system that adjusts a vertical position of the forward end and adjusts the vertical position of the rearward end to lower the deck between a raised horizontal orientation and a lowered horizontal orientation.

C. The adjustable deck system of Clause A, wherein the actuator comprises a motor, which operates to rotate the support between the stowed position and the deployed position.

D. The adjustable deck system of Clauses A and C, wherein the motor is an electric motor.

E. The adjustable deck system of Clauses A and C, wherein the actuator includes a pneumatic drive unit operable to rotate the support.

F. The adjustable deck system of Clauses A and C, wherein the automatic deck support comprises a control unit configured to programmatically control operations of the motor.

G. The adjustable deck system of Clauses A, C and F, wherein: the support comprises a first support; the actuator comprises a first actuator; and the automatic deck support further comprises: a second support that is rotatably coupled to the wall of the cargo container; and a second actuator that, independently of operations associated with the support, rotates the second support between a stowed position and a deployed position.

H. The adjustable deck system of Clauses A, C, F and G, wherein the second support is configured to support a second deck, which is positioned forward of the deck.

I. The adjustable deck system of Clause A, wherein: the deck lift system comprises a lift motor; and the actuator is controllable independently of the lift motor.

J. The adjustable deck system of Clause A, further comprising: a deck lift support that vertically traverses along the wall and that supports the deck; and a lift support brace that is fixedly positioned directly underneath the deck lift support and that supportively engages the deck lift support when the vertical position of the rearward end is adjusted.

K. The adjustable deck system of Clauses A and J, wherein: the deck is a second deck; the adjustable deck system further comprises a first deck that is positioned forward of the second deck; and when the lift support brace supportively engages the deck lift support, an upper surface of the second deck that is vertically aligned with the deck lift support is lower than an upper surface of the first deck.

L. The adjustable deck system of Clauses A, J and K, wherein when the lift support brace supportively engages the deck lift support and the second deck is in ramped orientation, a rear edge of the upper surface of the second deck is horizontally aligned with the upper surface of the first deck.

M. An adjustable deck system for a cargo container, the adjustable deck system comprising: a deck comprising a forward end oriented towards a front of the cargo container and a rearward end oriented towards a rear of the cargo container; a deck lift system that adjusts a vertical position of the rearward end to convert the deck between a horizontal orientation and a ramped orientation; a deck lift support that is coupled to the deck near the forward end and that, via the deck lift system, vertically traverses along a wall of the cargo container; and a lift support brace that is aligned directly underneath the deck lift support and that supportively engages the deck lift support when the vertical position of the rearward end is adjusted.

N. The adjustable deck system of Clause M, wherein: the deck is a second deck; the adjustable deck system further comprises a first deck that is positioned forward of the second deck; and when the lift support brace supportively engages the deck lift support, an upper surface of the second deck that is vertically aligned with the deck lift support is lower than an upper surface of the first deck.

O. The adjustable deck system of Clauses N, M, wherein when the lift support brace supportively engages the deck lift support and the second deck is in ramped orientation, a forward edge of the upper surface of the second deck is horizontally aligned with the upper surface of the first deck.

P. The adjustable deck system of Clause M, further comprising, an automatic deck support comprising: a support that is rotatably coupled to a wall of the cargo container; and an actuator that rotates the support between a stowed position, which is vertically offset from the deck, and a deployed position which is vertically aligned with the deck.

Q. The adjustable deck system of Clauses M and P, wherein the actuator comprises a motor, which operates to rotate the support between the stowed position and the deployed position.

R. A method comprising: vertically lowering a second deck from an elevated position to a lowered position, wherein the deck is a component of an adjustable deck system for a cargo container and comprises a forward end oriented towards a front of the cargo container and a rearward end oriented towards a rear of the cargo container; stopping vertical movement of the forward end at a position that is below an upper surface of a first deck; vertically lowering the rearward end below the position of the forward end, while the vertical movement of the forward end is stopped, such that a forward edge of the second deck rotates upward; and stopping vertical lowering of the rearward end such that the forward edge is horizontally aligned with the upper surface of the first deck.

S. The method of Clause R, further comprising: supporting, while vertically lowering the rearward end, a portion of the forward end on a lift support brace affixed to the cargo container.

T. The method of Clause R, further comprising: prior to vertically lowering the second deck from the elevated position, vertically raising the second deck to disengage the second deck from a deck support; and moving, via an actuator, the deck support from a deployed position, which is vertically aligned with the second deck, to a stowed position, which is vertically offset from the deck.

U. A cargo-loading deck comprising: a deck comprising a forward end oriented towards a front of a cargo container and a rearward end oriented towards a rear of the cargo container; a deck lift system that adjusts a vertical position of the rearward end to convert the deck between a horizontal orientation and a ramped orientation; and one or more ramp assist members rotatably attached to the rearward end, wherein the one or more ramp assist members adjust between a stowed position and a deployed position.

V. The cargo-loading deck of Clause U, further comprising a slotted bracket affixed to the rear of the rearward end; and a protrusion affixed to the one or more ramp assist members that is configured to engage the slotted bracket.

X. The cargo-loading deck of Clause V, wherein the slotted bracket includes a first segment and a second segment continuous with the first segment and oriented perpendicular to the first segment.

Y. The cargo-loading deck of Clause X, wherein adjusting the one or more ramp assist members from a deployed position to a stowed position comprises: lifting the one or more ramp assist members to move the protrusion along the first segment of the slotted bracket; sliding the one or more ramp assist members outward to move the protrusion along the second segment of the slotted bracket; rotating the one or more ramp assist members upward about 90 degrees; and sliding the one or more ramp assist members forward to move the protrusion along the second segment of the slotted bracket until the protrusion drops into the first segment of the slotted bracket.

Z. The cargo-loading deck of Clause X, wherein the adjusting the one or more rear assist members from a stowed position to a deployed position includes: lifting the one or more rear assist members up to move the protrusion along the first segment of the slotted bracket; sliding the one or more rear assist members outward to move the protrusion along the second segment of the slotted bracket; rotating the one or more rear assist members downward about 90 degrees; and sliding the one or more rear assist members inward to move the protrusion along the second segment of the slotted bracket until the protrusion drops into the first segment of the slotted bracket.

AA. The cargo-loading deck of Clause U, wherein the one or more rear assist members operate, when in a stowed position, as a stop to impede objects from moving beyond the rearward end.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

This detailed description is provided in order to meet statutory requirements. However, this description is not intended to limit the scope of the invention described herein. Rather, the claimed subject matter may be embodied in different ways, to include different steps, different combinations of steps, different elements, and/or different combinations of elements, similar or equivalent to those described in this disclosure, and in conjunction with other present or future technologies. The examples herein are intended in all respects to be illustrative rather than restrictive. In this sense, alternative examples or implementations can become apparent to those of ordinary skill in the art to which the present subject matter pertains without departing from the scope hereof.

Claimed is:

1. An adjustable deck system for a cargo container, the adjustable deck system comprising:
a deck comprising a forward end oriented towards a front of the cargo container and a rearward end oriented towards a rear of the cargo container;
a deck lift system that adjusts a vertical position of the rearward end to convert the deck between a horizontal orientation and a ramped orientation; and
an automatic deck support comprising:
a support that is rotatably coupled to a wall of the cargo container; and
an actuator that rotates the support between a stowed position, which is vertically offset from the deck, and a deployed position which is vertically aligned with the deck.

2. The adjustable deck system of claim 1, further comprising the deck lift system that adjusts a vertical position of the forward end and adjusts the vertical position of the rearward end to lower the deck between a raised horizontal orientation and a lowered horizontal orientation.

3. The adjustable deck system of claim 1, wherein the actuator comprises a motor, which operates to rotate the support between the stowed position and the deployed position.

4. The adjustable deck system of claim 3, wherein the motor is an electric motor.

5. The adjustable deck system of claim 3, wherein the actuator includes a pneumatic drive unit operable to rotate the support.

6. The adjustable deck system of claim 3, wherein the automatic deck support comprises a control unit configured to programmatically control operations of the motor.

7. The adjustable deck system of claim 6, wherein:
the support comprises a first support;
the actuator comprises a first actuator; and
the automatic deck support further comprises:
a second support that is rotatably coupled to the wall of the cargo container; and
a second actuator that, independently of operations associated with the support, rotates the second support between a stowed position and a deployed position.

8. The adjustable deck system of claim 7, wherein the second support is configured to support a second deck, which is positioned forward of the deck.

9. The adjustable deck system of claim 1, wherein:
the deck lift system comprises a lift motor; and
the actuator is controllable independently of the lift motor.

10. The adjustable deck system of claim 1, further comprising:
a deck lift support that vertically traverses along the wall and that supports the deck; and
a lift support brace that is fixedly positioned directly underneath the deck lift support and that supportively engages the deck lift support when the vertical position of the rearward end is adjusted.

11. The adjustable deck system of claim 10, wherein:
the deck is a second deck;
the adjustable deck system further comprises a first deck that is positioned forward of the second deck; and
when the lift support brace supportively engages the deck lift support, an upper surface of the second deck that is vertically aligned with the deck lift support is lower than an upper surface of the first deck.

12. The adjustable deck system of claim 11, wherein when the lift support brace supportively engages the deck lift support and the second deck is in ramped orientation, a rear edge of the upper surface of the second deck is horizontally aligned with the upper surface of the first deck.

13. An adjustable deck system for a cargo container, the adjustable deck system comprising:
a deck comprising a forward end oriented towards a front of the cargo container and a rearward end oriented towards a rear of the cargo container;
a deck lift system that adjusts a vertical position of the rearward end to convert the deck between a horizontal orientation and a ramped orientation;
a deck lift support that is coupled to the deck near the forward end and that, via the deck lift system, vertically traverses along a wall of the cargo container; and
a lift support brace that is aligned directly underneath the deck lift support and that supportively engages the deck lift support when the vertical position of the rearward end is adjusted.

14. The adjustable deck system of claim 13, wherein:
the deck is a second deck;
the adjustable deck system further comprises a first deck that is positioned forward of the second deck; and
when the lift support brace supportively engages the deck lift support, an upper surface of the second deck that is vertically aligned with the deck lift support is lower than an upper surface of the first deck.

15. The adjustable deck system of claim 14, wherein when the lift support brace supportively engages the deck lift support and the second deck is in ramped orientation, a forward edge of the upper surface of the second deck is horizontally aligned with the upper surface of the first deck.

16. The adjustable deck system of claim 13, further comprising, an automatic deck support comprising:
a support that is rotatably coupled to a wall of the cargo container; and
an actuator that rotates the support between a stowed position, which is vertically offset from the deck, and a deployed position which is vertically aligned with the deck.

17. The adjustable deck system of claim 16, wherein the actuator comprises a motor, which operates to rotate the support between the stowed position and the deployed position.

18. A method comprising:
vertically lowering a second deck from an elevated position to a lowered position, wherein the second deck is a component of an adjustable deck system for a cargo container and comprises a forward end oriented towards a front of the cargo container and a rearward end oriented towards a rear of the cargo container;
stopping vertical movement of the forward end at a position that is below an upper surface of a first deck;
vertically lowering the rearward end below the position of the forward end, while the vertical movement of the forward end is stopped, such that a forward edge of the second deck rotates upward; and
stopping vertical lowering of the rearward end such that the forward edge is horizontally aligned with the upper surface of the first deck.

19. The method of claim 18, further comprising:
supporting, while vertically lowering the rearward end, a portion of the forward end on a lift support brace affixed to the cargo container.

20. The method of claim 18, further comprising:
prior to vertically lowering the second deck from the elevated position, vertically raising the second deck to disengage the second deck from a deck support; and
moving, via an actuator, the deck support from a deployed position, which is vertically aligned with the second deck, to a stowed position, which is vertically offset from the first deck.

21. A cargo-loading deck comprising:
a deck comprising a forward end oriented towards a front of a cargo container and a rearward end oriented towards a rear of the cargo container;
a deck lift system that adjusts a vertical position of the rearward end to convert the deck between a horizontal orientation and a ramped orientation; and
one or more ramp assist members rotatably attached to the rearward end, wherein the one or more ramp assist members adjust between a stowed position and a deployed position.

22. The cargo-loading deck of claim 21, further comprising:
a slotted bracket affixed to the rear of the rearward end; and
a protrusion affixed to the one or more ramp assist members that is configured to engage the slotted bracket.

23. The adjustable deck system of claim 22, wherein the slotted bracket includes a first segment and a second segment continuous with the first segment and oriented perpendicular to the first segment.

24. The adjustable deck system of claim 23, wherein adjusting the one or more ramp assist members from a deployed position to a stowed position comprises:
lifting the one or more ramp assist members to move the protrusion along the first segment of the slotted bracket;
sliding the one or more ramp assist members outward to move the protrusion along the second segment of the slotted bracket;
rotating the one or more ramp assist members upward about 90 degrees; and
sliding the one or more ramp assist members forward to move the protrusion along the second segment of the slotted bracket until the protrusion drops into the first segment of the slotted bracket.

25. The adjustable deck system of claim 23, wherein the adjusting the one or more rear assist members from a stowed position to a deployed position includes:
lifting the one or more rear assist members up to move the protrusion along the first segment of the slotted bracket;
sliding the one or more rear assist members outward to move the protrusion along the second segment of the slotted bracket;
rotating the one or more rear assist members downward about 90 degrees; and
sliding the one or more rear assist members inward to move the protrusion along the second segment of the slotted bracket until the protrusion drops into the first segment of the slotted bracket.

26. The adjustable deck system of claim 21, wherein the one or more rear assist members operate, when in a stowed position, as a stop to impede objects from moving beyond the rearward end.
